(19) United States
(12) Patent Application Publication
(10) Pub. No.: US 2020/0224524 A1
(43) Pub. Date: Jul. 16, 2020

(54) Utilizing Vision Systems at a Wellsite

(71) Applicant: Schlumberger Technology Corporation, Sugar Land, TX (US)

(72) Inventors: Vishwanathan Parmeshwar, Houston, TX (US); Manat Singh, Houston, TX (US); Richard Wang, Katy, TX (US)

(21) Appl. No.: 16/247,868

(22) Filed: Jan. 15, 2019

(51) Int. Cl. E21B 44/00; E21B 41/00; H04N 7/18; G08B 5/22; G08B 3/10

(52) U.S. Cl. CPC E21B 44/00; E21B 41/0021; G08B 3/10; G08B 5/22; H04N 7/183

(57) ABSTRACT

Utilizing vision systems at a wellsite, which may include operating a video camera to generate a video signal comprising images of one or more pieces of equipment or components and receiving the video signal by a processing system, which may then process the images to monitor or determine physical and/or operational characteristics associated with the one or more pieces of equipment in the images. The physical and/or operational characteristics may include wear of a drill bit for drilling wellbores, alignment between pieces of equipment or components at the wellsite, and/or safety compliance at the wellsite.

### BACKGROUND OF THE DISCLOSURE

Wells are generally drilled into the ground or ocean bed to recover natural deposits of oil, gas, and other materials that are trapped in subterranean formations. Well construction operations (e.g., drilling operations) may be performed at a wellsite by a drilling system having various surface and subterranean equipment operating in a coordinated manner. The wellsite equipment may be grouped into various subsystems, wherein each subsystem performs a different operation controlled by a corresponding local and/or a remotely located controller.

A video system, such as a CCTV system, comprising a plurality of video cameras distributed at various locations at a wellsite is utilized to display selected wellsite equipment on one or more video monitors to facilitate viewing of the wellsite equipment and progress of the well construction operations. For example, a human wellsite operator (e.g., a driller) may utilize the video system to visually monitor and confirm successive operational stages of the well construction operations and/or to identify operational and safety events associated with the wellsite equipment. After visually confirming an operational stage or a safety event, the wellsite operator may then permit the well construction operations to proceed to a subsequent operational stage or initiate processes to counteract a detected safety event. The video system may also be utilized for security and/or surveillance purposes at the wellsite.

A video system is primarily used as a supervisory tool to help wellsite operators to view and, thus, manage operations of wellsite equipment captured by the video cameras. However, images (or video frames) of the wellsite equipment captured by the video cameras also comprise information indicative of certain physical characteristics and/or operational status of such wellsite equipment that may not be recognized or otherwise appreciated by the wellsite operators viewing the images on a video monitor. Thus, computer vision technology can be utilized to acquire, process, analyze, and understand the images captured by the video cameras to determine such physical characteristics and/or operational status, present the determined physical characteristics and/or operational status to the wellsite operators, and/or automate selected wellsite operations based on the determined physical characteristics and/or operational status of the wellsite equipment. The physical characteristics and operational status of the wellsite equipment that may be monitored via the video cameras include, for example, length, distance, position, and orientation of the wellsite equipment, maintenance (e.g., wear) status of the wellsite equipment, and health, safety, and environmental (HSE) regulation compliance of the wellsite equipment and/or by the wellsite operators.

### SUMMARY OF THE DISCLOSURE

This summary is provided to introduce a selection of concepts that are further described below in the detailed description. This summary is not intended to identify indispensable features of the claimed subject matter, nor is it intended for use as an aid in limiting the scope of the claimed subject matter.

The present disclosure introduces an apparatus including a first downhole tubular configured for threadedly coupling with a second downhole tubular and conveyance within a wellbore by an oil and/or gas drilling rig. An outer surface of the first downhole tubular includes a geometric pattern for determining azimuthal orientation of the first downhole tubular.

The present disclosure also introduces a method including imparting a geometric pattern onto an outer surface of a downhole tubular. The geometric pattern is for determining azimuthal orientation of the downhole tubular while the downhole tubular is threadedly coupled with another downhole tubular for conveyance within a wellbore.

The present disclosure also introduces a method including operating a video camera to generate a signal related to images of a geometric pattern on an outer surface of a first downhole tubular while the first downhole tubular is being threadedly coupled with a second downhole tubular at an oil and gas wellsite. A processing system is operated to process the signal to determine an azimuthal orientation of the first downhole tubular based on the images of the geometric pattern.

The present disclosure also introduces a method that includes operating a video camera to generate a video signal associated with images encompassing a top of a tubular extending above an elevator of a drill rig at an oil and gas wellsite while the tubular is retained by the elevator. A processing system is operated to process the video signal to determine a height of the top of the tubular relative to the rig floor of the drill rig.

The present disclosure also introduces a method that includes operating a video camera to generate a video signal related to images encompassing at least a portion of a crown block of a hoisting system of an oil and gas drill rig. A processing system is operated to process the video signal to determine when a traveling block or elevator of the hoisting system is within a threshold distance from the crown block.

The present disclosure also introduces a method that includes operating a video camera to generate a video signal pertaining to images encompassing at least a portion of a drawworks of a hoisting system of an oil and gas drill rig. A processing system is operated to process the video signal to determine when a traveling block or elevator of the hoisting system is within a threshold distance from the crown block.

The present disclosure also introduces a method including monitoring alignment between a pin end of an upper tubular and a box end of a lower tubular during tubular make up operations at an oil and gas wellsite. The monitoring is performed by operating a first video camera to generate a first video signal related to first images encompassing the pin end of the upper tubular and the box end of the lower tubular, and by operating a second video camera to generate a second video signal related to second images encompassing the pin end of the upper tubular and the box end of the lower tubular. The first and second video cameras are directed at the pin end of the upper tubular and the box end of the lower tubular from different angles. A processing system is operated to process the first and second video signals to determine an amount of misalignment between the pin end of the upper tubular and the box end of the lower tubular captured in the first and second images.

The present disclosure also introduces a method that includes operating a video camera to generate a signal associated with an image of at least a portion of a drill bit for drilling a wellbore. A processing system is operated to process the signal to determine an amount of wear experienced by the drill bit.

The present disclosure also introduces a method that includes operating a video camera at an oil and gas wellsite to generate a signal related to images encompassing safety regulation compliance indicators. A processing system is operated to process the signal to determine compliance with the safety regulations at the oil and gas wellsite, and to initiate an alarm when the processed signal is indicative of noncompliance with one or more of the safety regulations.

The present disclosure also introduces a method that includes operating a video camera to capture a first image of a mark located on a first tubular while the first tubular is engaged by a top drive and a second tubular coupled with the first tubular is engaged by slips of a drilling rig including the top drive, and to capture a second image of the mark while the first tubular remains engaged by the top drive and the second tubular is not engaged by the slips. The method also includes determining an amount of stretch of the first tubular by determining a change in position of the mark among the first and second images. Determining the mark position change among the first and second images includes operating a processing system having a processor and a memory storing computer program code.

The present disclosure also introduces a method that includes operating a video camera to generate a video signal pertaining to images encompassing a mark located on an uppermost tubular of a tubular string extending within a wellbore at an oil and gas wellsite. A depth at which the tubular string is stuck within the wellbore is determined by pulling the tubular string while determining a resulting amount of stretch of the uppermost tubular, and determining the depth based at least partially on the determined stretch.

These and additional aspects of the present disclosure are set forth in the description that follows, and/or may be learned by a person having ordinary skill in the art by reading the material herein and/or practicing the principles described herein. At least some aspects of the present disclosure may be achieved via means recited in the attached claims.

### BRIEF DESCRIPTION OF THE DRAWINGS

The present disclosure is understood from the following detailed description when read with the accompanying figures. It is emphasized that, in accordance with the standard practice in the industry, various features are not drawn to scale. In fact, the dimensions of the various features may be arbitrarily increased or reduced for clarity of discussion.

FIG. 1 is a schematic view of at least a portion of an example implementation of apparatus according to one or more aspects of the present disclosure.

FIG. 2 is a schematic view of at least a portion of an example implementation of apparatus according to one or more aspects of the present disclosure.

FIG. 3 is a schematic view of at least a portion of an example implementation of apparatus according to one or more aspects of the present disclosure.

FIG. 4 is a schematic view of at least a portion of an example implementation of apparatus according to one or more aspects of the present disclosure.

FIG. 5 is a schematic view of at least a portion of an example implementation of apparatus according to one or more aspects of the present disclosure.

FIG. 6 is a schematic view of at least a portion of an example implementation of apparatus according to one or more aspects of the present disclosure.

FIG. 7 is a schematic view of at least a portion of an example implementation of apparatus according to one or more aspects of the present disclosure.

FIG. 8 is a schematic view of at least a portion of an example implementation of apparatus according to one or more aspects of the present disclosure.

FIG. 9 is a schematic view of at least a portion of an example implementation of apparatus according to one or more aspects of the present disclosure.

FIG. 10 is a perspective view of a portion of the apparatus shown in FIG. 9 according to one or more aspects of the present disclosure.

FIG. 11 is a perspective view of a portion of the apparatus shown in FIG. 10 according to one or more aspects of the present disclosure.

FIG. 12 is a schematic view of at least a portion of an example implementation of apparatus according to one or more aspects of the present disclosure.

FIG. 13 is a perspective view of a portion of the apparatus shown in FIG. 12 according to one or more aspects of the present disclosure.

FIG. 14 is a perspective view of a portion of the apparatus shown in FIG. 13 according to one or more aspects of the present disclosure.

FIG. 15 is a schematic view of at least a portion of an example implementation of apparatus according to one or more aspects of the present disclosure.

FIG. 16 is a schematic view of at least a portion of an example implementation of apparatus according to one or more aspects of the present disclosure.

FIG. 17 is a schematic view of at least a portion of an example implementation of apparatus according to one or more aspects of the present disclosure.

FIG. 18 is a chart related to one or more aspects of the present disclosure.

FIG. 19 is a schematic view of at least a portion of an example implementation of apparatus according to one or more aspects of the present disclosure.

FIG. 20 is an enlarged view of a portion of the apparatus shown in FIG. 19 according to one or more aspects of the present disclosure.

FIG. 21 is a view of the apparatus shown in FIG. 20 in another operational state according to one or more aspects of the present disclosure.

FIG. 22 is a schematic view of at least a portion of an example implementation of apparatus according to one or more aspects of the present disclosure.

### DETAILED DESCRIPTION

It is to be understood that the following disclosure provides many different embodiments, or examples, for implementing different features of various embodiments. Specific examples of components and arrangements are described below to simplify the present disclosure. These are, of course, merely examples and are not intended to be limiting. In addition, the present disclosure may repeat reference numerals and/or letters in the various examples. This repetition is for simplicity and clarity, and does not in itself dictate a relationship between the various embodiments and/or configurations discussed.

Systems and methods (e.g., processes, operations) according to one or more aspects of the present disclosure may be utilized or otherwise implemented in association with an automated well construction system at an oil and gas wellsite, such as for constructing a wellbore to obtain hydrocarbons (e.g., oil and/or gas) from a subterranean formation. However, one or more aspects of the present disclosure may be utilized or otherwise implemented in association with other automated systems in the oil and gas industry and other industries. For example, one or more aspects of the present disclosure may be implemented in association with wellsite systems for performing fracturing, cementing, acidizing, chemical injecting, and/or water jet cutting operations, among other examples. One or more aspects of the present disclosure may also be implemented in association with mining sites, building construction sites, and/or other work sites where automated machines or equipment are utilized.

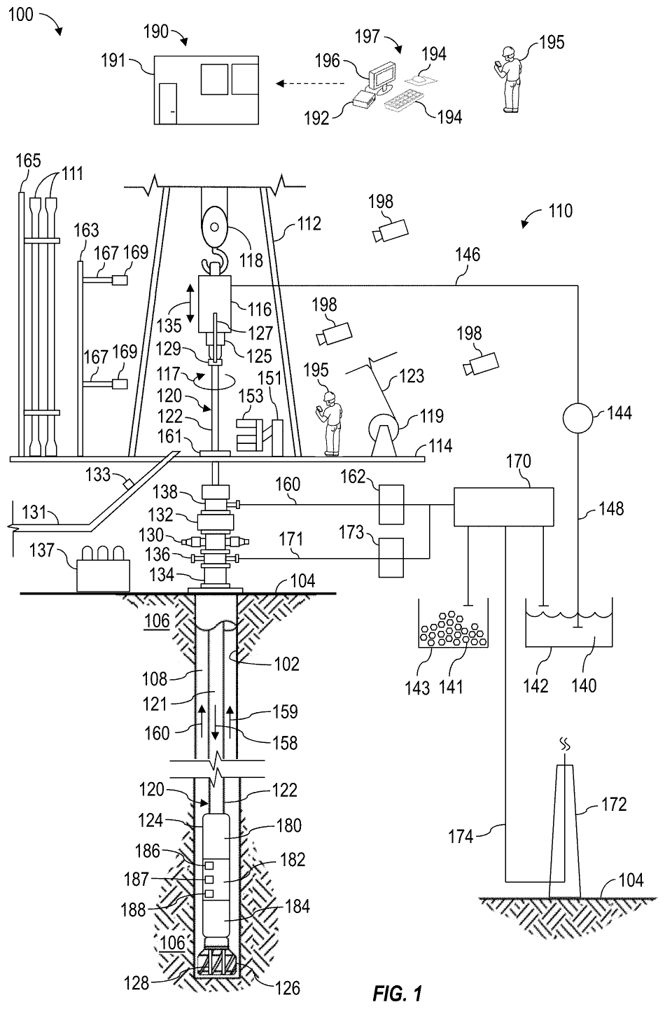

FIG. 1 is a schematic view of at least a portion of an example implementation of a well construction system 100 according to one or more aspects of the present disclosure. The well construction system 100 represents an example environment in which one or more aspects of the present disclosure described below may be implemented. Although the well construction system 100 is depicted as an onshore implementation, the aspects described below are also applicable to offshore implementations.

The well construction system 100 is depicted in relation to a wellbore 102 formed by rotary and/or directional drilling from a wellsite surface 104 and extending into a subterranean formation 106. The well construction system 100 includes surface equipment 110 located at the wellsite surface 104 and a drill string 120 suspended within the wellbore 102. The surface equipment 110 may include a mast, a derrick, and/or another support structure 112 disposed over a rig floor 114. The drill string 120 may be suspended within the wellbore 102 from the support structure 112. The support structure 112 and the rig floor 114 are collectively supported over the wellbore 102 by legs and/or other support structures (not shown).

The drill string 120 may comprise a bottom-hole assembly (BHA) 124 and means 122 for conveying the BHA 124 within the wellbore 102. The conveyance means 122 may comprise drill pipe, heavy-weight drill pipe (HWDP), wired drill pipe (WDP), tough logging condition (TLC) pipe, coiled tubing, and/or other means for conveying the BHA 124 within the wellbore 102. A downhole end of the BHA 124 may include or be coupled to a drill bit 126. Rotation of the drill bit 126 and the weight of the drill string 120 collectively operate to form the wellbore 102. The drill bit 126 may be rotated from the wellsite surface 104 and/or via a downhole mud motor (not shown) connected with the drill bit 126.

The BHA 124 may also include various downhole tools 180, 182, 184. One or more of such downhole tools 180, 182, 184 may be or comprise an acoustic tool, a density tool, a directional drilling tool, an electromagnetic (EM) tool, a formation sampling tool, a formation testing tool, a gravity tool, a monitoring tool, a neutron tool, a nuclear tool, a photoelectric factor tool, a porosity tool, a reservoir characterization tool, a resistivity tool, a rotational speed sensing tool, a sampling-while-drilling (SWD) tool, a seismic tool, a surveying tool, a torsion sensing tool, and/or other measurement-while-drilling (MWD) or logging-while-drilling (LWD) tools.

One or more of the downhole tools 180, 182, 184 may be or comprise an MWD or LWD tool comprising a sensor package 186 operable for the acquisition of measurement data pertaining to the BHA 124, the wellbore 102, and/or the formation 106. One or more of the downhole tools 180, 182, 184 and/or another portion of the BHA 124 may also comprise a telemetry device 187 operable for communication with the surface equipment 110, such as via mud-pulse telemetry. One or more of the downhole tools 180, 182, 184 and/or another portion of the BHA 124 may also comprise a downhole processing device 188 operable to receive, process, and/or store information received from the surface equipment 110, the sensor package 186, and/or other portions of the BHA 124. The processing device 188 may also store executable computer programs (e.g., program code instructions), including for implementing one or more aspects of the operations described herein.

The support structure 112 may support a driver, such as a top drive 116, operable to connect (perhaps indirectly) with an uphole end of the conveyance means 122, and to impart rotary motion 117 and vertical motion 135 to the drill string 120 and the drill bit 126. However, another driver, such as a kelly and rotary table (neither shown), may be utilized instead of or in addition to the top drive 116 to impart the rotary motion 117. The top drive 116 and the connected drill string 120 may be suspended from the support structure 112 via hoisting equipment, which may include a traveling block 118, a crown block (not shown), and a drawworks 119 storing a support cable or line 123. The crown block may be connected to or otherwise supported by the support structure 112, and the traveling block 118 may be coupled with the top drive 116, such as via a hook. The drawworks 119 may be mounted on or otherwise supported by the rig floor 114. The crown block and traveling block 118 comprise pulleys or sheaves around which the support line 123 is reeved to operatively connect the crown block, the traveling block 118, and the drawworks 119 (and perhaps an anchor). The drawworks 119 may thus selectively impart tension to the support line 123 to lift and lower the top drive 116, resulting in the vertical motion 135. The drawworks 119 may comprise a drum, a frame, and a prime mover (e.g., an engine or motor) (not shown) operable to drive the drum to rotate and reel in the support line 123, causing the traveling block 118 and the top drive 116 to move upward. The drawworks 119 may be operable to release the support line 123 via a controlled rotation of the drum, causing the traveling block 118 and the top drive 116 to move downward.

The top drive 116 may comprise a grabber, a swivel (neither shown), a tubular handling assembly links 127 terminating with an elevator 129, and a drive shaft 125 operatively connected with a prime mover (not shown), such as via a gear box or transmission (not shown). The drill string 120 may be mechanically coupled to the drive shaft 125 with or without a sub saver between the drill string 120 and the drive shaft 125. The prime mover may be selectively operated to rotate the drive shaft 125 and the drill string 120 coupled with the drive shaft 125. Hence, during drilling operations, the top drive 116 in conjunction with operation of the drawworks 119 may advance the drill string 120 into the formation 106 to form the wellbore 102. The tubular handling assembly links 127 and the elevator 129 of the top drive 116 may handle tubulars (e.g., drill pipes, drill collars, casing joints, etc.) that are not mechanically coupled to the drive shaft 125. For example, when the drill string 120 is being tripped into or out of the wellbore 102, the elevator 129 may grasp the tubulars of the drill string 120 such that the tubulars may be raised and/or lowered via the hoisting equipment mechanically coupled to the top drive 116. The grabber may include a clamp that clamps onto a tubular when making up and/or breaking out a connection of a tubular with the drive shaft 125. The top drive 116 may have a guide system (not shown), such as rollers that track up and down a guide rail on the support structure 112. The guide system may aid in keeping the top drive 116 aligned with the wellbore 102, and in preventing the top drive 116 from rotating during drilling by transferring reactive torque to the support structure 112.

The well construction system 100 may further include a well control system for maintaining well pressure control. For example, the drill string 120 may be conveyed within the wellbore 102 through various blowout preventer (BOP) equipment disposed at the wellsite surface 104 on top of the wellbore 102 and perhaps below the rig floor 114. The BOP equipment may be operable to control pressure within the wellbore 102 via a series of pressure barriers (e.g., rams) between the wellbore 102 and the wellsite surface 104. The BOP equipment may include a BOP stack 130, an annular preventer 132, and/or a rotating control device (RCD) 138 mounted above the annular preventer 132. The BOP equipment 130, 132, 138 may be mounted on top of a wellhead 134. The well control system may further include a BOP control unit 137 (i.e., a BOP closing unit) operatively connected with the BOP equipment 130, 132, 138 and operable to actuate, drive, operate or otherwise control the BOP equipment 130, 132, 138. The BOP control unit 137 may be or comprise a hydraulic fluid power unit fluidly connected with the BOP equipment 130, 132, 138 and selectively operable to hydraulically drive various portions (e.g., rams, valves, seals) of the BOP equipment 130, 132, 138.

The well construction system 100 may further include a drilling fluid circulation system operable to circulate fluids between the surface equipment 110 and the drill bit 126 during drilling and other operations. For example, the drilling fluid circulation system may be operable to inject a drilling fluid from the wellsite surface 104 into the wellbore 102 via an internal fluid passage 121 extending longitudinally through the drill string 120. The drilling fluid circulation system may comprise a pit, a tank, and/or other fluid container 142 holding the drilling fluid (i.e., mud) 140, and a pump 144 operable to move the drilling fluid 140 from the container 142 into the fluid passage 121 of the drill string 120 via a fluid conduit 146 extending from the pump 144 to the top drive 116 and an internal passage extending through the top drive 116. The fluid conduit 146 may comprise one or more of a pump discharge line, a stand pipe, a rotary hose, and a gooseneck (not shown) connected with a fluid inlet of the top drive 116. The pump 144 and the container 142 may be fluidly connected by a fluid conduit 148, such as a suction line.

During drilling operations, the drilling fluid may continue to flow downhole through the internal passage 121 of the drill string 120, as indicated by directional arrow 158. The drilling fluid may exit the BHA 124 via ports 128 in the drill bit 126 and then circulate uphole through an annular space 108 (“annulus”) of the wellbore 102 defined between an exterior of the drill string 120 and the wall of the wellbore 102, such flow being indicated by directional arrows 159. In this manner, the drilling fluid lubricates the drill bit 126 and carries formation cuttings uphole to the wellsite surface 104. The returning drilling fluid may exit the annulus 108 via the RCD 138 and/or via a spool, a wing valve, a bell nipple, or another ported adapter 136, which may be located below one or more portions of the BOP stack 130.

The drilling fluid exiting the annulus 108 via the RCD 138 may be directed into a fluid conduit 160 (e.g., a drilling pressure control line), and may pass through various wellsite equipment fluidly connected along the conduit 160 prior to being returned to the container 142 for recirculation. For example, the drilling fluid may pass through a choke manifold 162 (e.g., a drilling pressure control choke manifold) connected along the conduit 160. The choke manifold 162 may include at least one choke and a plurality of fluid valves (neither shown) collectively operable to control the flow through and out of the choke manifold 162. Backpressure may be applied to the annulus 108 by variably restricting flow of the drilling fluid or other fluids flowing through the choke manifold 162. The greater the restriction to flow through the choke manifold 162, the greater the backpressure applied to the annulus 108.

The drilling fluid may also or instead exit the annulus 108 via the ported adapter 136 and into a fluid conduit 171 (e.g., rig choke line), and may pass through various equipment fluidly connected along the conduit 171 prior to being returned to the container 142 for recirculation. For example, the drilling fluid may pass through a choke manifold 173 (e.g., a rig choke manifold) connected along the conduit 171. The choke manifold 173 may include at least one choke and a plurality of fluid valves (neither shown) collectively operable to control the flow through the choke manifold 173. Backpressure may be applied to the annulus 108 by variably restricting flow of the drilling fluid or other fluids flowing through the choke manifold 173.

Before being returned to the container 142, the drilling fluid returning to the wellsite surface 104 may be cleaned and/or reconditioned via drilling fluid reconditioning equipment 170, which may include one or more of liquid gas separators, shale shakers, centrifuges, and other drilling fluid cleaning equipment. The liquid gas separators may remove formation gasses entrained in the drilling fluid discharged from the wellbore 102 and the shale shakers may separate and remove solid particles 141 (e.g., drill cuttings) from the drilling fluid. The drilling fluid reconditioning equipment 170 may further comprise equipment operable to remove additional gas and finer formation cuttings from the drilling fluid and/or modify physical properties or characteristics (e.g., rheology) of the drilling fluid. For example, the drilling fluid reconditioning equipment 170 may include a degasser, a desander, a desilter, a mud cleaner, and/or a decanter, among other examples. Intermediate tanks/containers (not shown) may be utilized to hold the drilling fluid while the drilling fluid progresses through the various stages or portions of the drilling fluid reconditioning equipment 170. The cleaned/reconditioned drilling fluid may be transferred to the fluid container 142, the solid particles 141 removed from the drilling fluid may be transferred to a solids container 143 (e.g., a reserve pit), and/or the removed gas may be transferred to a flare stack 172 via a conduit 174 (e.g., a flare line) to be burned or to a container (not shown) for storage and removal from the wellsite.

The surface equipment 110 may include tubular handling equipment operable to store, move, connect, and disconnect tubulars (e.g., drill pipes) to assemble and disassemble the conveyance means 122 of the drill string 120 during drilling operations. For example, a catwalk 131 may be utilized to convey tubulars from a ground level, such as along the wellsite surface 104, to the rig floor 114, permitting the tubular handling assembly links 127 to grab and lift the tubulars above the wellbore 102 for connection with previously deployed tubulars. The catwalk 131 may have a horizontal portion and an inclined portion that extends between the horizontal portion and the rig floor 114. The catwalk 131 may comprise a skate 133 movable along a groove (not shown) extending longitudinally along the horizontal and inclined portions of the catwalk 131. The skate 133 may be operable to convey (e.g., push) the tubulars along the catwalk 131 to the rig floor 114. The skate 133 may be driven along the groove by a drive system (not shown), such as a pulley system or a hydraulic system. Additionally, one or more racks (not shown) may adjoin the horizontal portion of the catwalk 131.

An iron roughneck 151 may be positioned on the rig floor 114. The iron roughneck 151 may comprise a torqueing portion 153, such as may include a spinner and a torque wrench comprising a lower tong and an upper tong. The torqueing portion 153 of the iron roughneck 151 may be moveable toward and at least partially around the drill string 120, such as may permit the iron roughneck 151 to make up and break out connections of the drill string 120. The torqueing portion 153 may also be moveable away from the drill string 120, such as may permit the iron roughneck 151 to move clear of the drill string 120 during drilling operations. The spinner of the iron roughneck 151 may be utilized to apply low torque to make up and break out threaded connections between tubulars of the drill string 120, and the torque wrench may be utilized to apply a higher torque to tighten and loosen the threaded connections.

Reciprocating slips 161 may be located on the rig floor 114, such as may accommodate therethrough the downhole tubulars during make up and break out operations and during the drilling operations. The reciprocating slips 161 may be in an open position during drilling operations to permit advancement of the drill string 120 therethrough, and in a closed position to clamp an upper end of the conveyance means 122 (e.g., assembled tubulars) to thereby suspend and prevent advancement of the drill string 120 within the wellbore 102, such as during the make up and break out operations.

During drilling operations, the hoisting equipment lowers the drill string 120 while the top drive 116 rotates the drill string 120 to advance the drill string 120 downward within the wellbore 102 and into the formation 106. During the advancement of the drill string 120, the reciprocating slips 161 are in an open position, and the iron roughneck 151 is moved away or is otherwise clear of the drill string 120. When the upper portion of the tubular in the drill string 120 that is made up to the drive shaft 125 is near the reciprocating slips 161 and/or the rig floor 114, the top drive 116 ceases rotating and the reciprocating slips 161 close to clamp the tubular made up to the drive shaft 125. The grabber (not shown) of the top drive 116 then clamps the upper portion of the tubular made up to the drive shaft 125, and the drive shaft 125 rotates in a direction reverse from the drilling rotation to break out the connection between the drive shaft 125 and the made up tubular. The grabber of the top drive 116 may then release the tubular of the drill string 120.

Multiple tubulars may be loaded on the rack of the catwalk 131 and individual tubulars (or stands of two or three tubulars) may be transferred from the rack to the groove in the catwalk 131, such as by the spinner unit. The tubular positioned in the groove may be conveyed along the groove by the skate 133 until an end of the tubular projects above the rig floor 114. The elevator 129 of the top drive 116 then grasps the protruding end, and the drawworks 119 is operated to lift the top drive 116, the elevator 129, and the new tubular.

The hoisting equipment then raises the top drive 116, the elevator 129, and the tubular until the tubular is aligned with the upper portion of the drill string 120 clamped by the slips 161. The iron roughneck 151 is moved toward the drill string 120, and the lower tong of the torqueing portion 153 clamps onto the upper portion of the drill string 120. The spinning system rotates the new tubular (e.g., a threaded male end) into the upper portion of the drill string 120 (e.g., a threaded female end). The upper tong then clamps onto the new tubular and rotates with high torque to complete making up the connection with the drill string 120. In this manner, the new tubular becomes part of the drill string 120. The iron roughneck 151 then releases and moves clear of the drill string 120.

The grabber of the top drive 116 may then clamp onto the drill string 120. The drive shaft 125 (e.g., a threaded male end) is brought into contact with the drill string 120 (e.g., a threaded female end) and rotated to make up a connection between the drill string 120 and the drive shaft 125. The grabber then releases the drill string 120, and the reciprocating slips 161 are moved to the open position. The drilling operations may then resume.

The tubular handling equipment may further include a pipe handling manipulator (PHM) 163 disposed in association with a fingerboard 165. Although the PHM 163 and the fingerboard 165 are shown supported on the rig floor 114, one or both of the PHM 163 and fingerboard 165 may be located on the wellsite surface 104 or another area of the well construction system 100. The fingerboard 165 provides storage (e.g., temporary storage) of tubulars (or stands of two or three tubulars) 111 during various operations, such as during and between tripping out and tripping in the drill string 120. The PHM 163 may be operable to transfer the tubulars 111 between the fingerboard 165 and the drill string 120 (i.e., space above the suspended drill string 120). For example, the PHM 163 may include arms 167 terminating with clamps 169, such as may be operable to grasp and/or clamp onto one of the tubulars 111. The arms 167 of the PHM 163 may extend and retract, and/or at least a portion of the PHM 163 may be rotatable and/or movable toward and away from the drill string 120, such as may permit the PHM 163 to transfer the tubular 111 between the fingerboard 165 and the drill string 120.

To trip out the drill string 120, the top drive 116 is raised, the reciprocating slips 161 are closed around the drill string 120, and the elevator 129 is closed around the drill string 120. The grabber of the top drive 116 clamps the upper portion of the tubular made up to the drive shaft 125. The drive shaft 125 then rotates in a direction reverse from the drilling rotation to break out the connection between the drive shaft 125 and the drill string 120. The grabber of the top drive 116 then releases the tubular of the drill string 120, and the drill string 120 is suspended by (at least in part) the elevator 129. The iron roughneck 151 is moved toward the drill string 120. The lower tong clamps onto a lower tubular below a connection of the drill string 120, and the upper tong clamps onto an upper tubular above that connection. The upper tong then rotates the upper tubular to provide a high torque to break out the connection between the upper and lower tubulars. The spinning system then rotates the upper tubular to separate the upper and lower tubulars, such that the upper tubular is suspended above the rig floor 114 by the elevator 129. The iron roughneck 151 then releases the drill string 120 and moves clear of the drill string 120.

The PHM 163 may then move toward the drill string 120 to grasp the tubular suspended from the elevator 129. The elevator 129 then opens to release the tubular. The PHM 163 then moves away from the drill string 120 while grasping the tubular with the clamps 169, places the tubular in the fingerboard 165, and releases the tubular for storage in the fingerboard 165. This process is repeated until the intended length of drill string 120 is removed from the wellbore 102.

The surface equipment 110 of the well construction system 100 may also comprise a control center 190 from which various portions of the well construction system 100, such as the top drive 116, the hoisting system, the tubular handling system, the drilling fluid circulation system, the well control system, the BHA 124, among other examples, may be monitored and controlled. The control center 190 may be located on the rig floor 114 or another location of the well construction system 100, such as the wellsite surface 104. The control center 190 may comprise a facility 191 (e.g., a room, a cabin, a trailer, etc.) containing a control workstation 197, which may be operated by a human wellsite operator 195 to monitor and control various wellsite equipment or portions of the well construction system 100. The control workstation 197 may comprise or be communicatively connected with a processing device 192 (e.g., a controller, a computer, etc.), such as may be operable to receive, process, and output information to monitor operations of and provide control to one or more portions of the well construction system 100. For example, the processing device 192 may be communicatively connected with the various surface and downhole equipment described herein, and may be operable to receive signals from and transmit signals to such equipment to perform various operations described herein. The processing device 192 may store executable program code, instructions, and/or operational parameters or set-points, including for implementing one or more aspects of methods and operations described herein. The processing device 192 may be located within and/or outside of the facility 191.

The control workstation 197 may be operable for entering or otherwise communicating control commands to the processing device 192 by the wellsite operator 195, and for displaying or otherwise communicating information from the processing device 192 to the wellsite operator 195. The control workstation 197 may comprise a plurality of human-machine interface (HMI) devices, including one or more input devices 194 (e.g., a keyboard, a mouse, a joystick, a touchscreen, etc.) and one or more output devices 196 (e.g., a video monitor, a touchscreen, a printer, audio speakers, etc.). Communication between the processing device 192, the input and output devices 194, 196, and the various wellsite equipment may be via wired and/or wireless communication means. However, for clarity and ease of understanding, such communication means are not depicted, and a person having ordinary skill in the art will appreciate that such communication means are within the scope of the present disclosure.

Well construction systems within the scope of the present disclosure may include more or fewer components than as described above and depicted in FIG. 1. Additionally, various equipment and/or subsystems of the well construction system 100 shown in FIG. 1 may include more or fewer components than as described above and depicted in FIG. 1. For example, various engines, motors, hydraulics, actuators, valves, and/or other components not explicitly described herein may be included in the well construction system 100, and are within the scope of the present disclosure.

The well construction system 100 also includes stationary and/or mobile video cameras 198 disposed or utilized at various locations within the well construction system 100. The video cameras 198 capture videos of various portions, equipment, or subsystems of the well construction system 100, and perhaps the wellsite operators 195 and the actions they perform, during or otherwise in association with the wellsite operations, including while performing repairs to the well construction system 100 during a breakdown. For example, the video cameras 198 may capture digital images (or video frames) of the entire well construction system 100 and/or specific portions of the well construction system 100, such as the top drive 116, the iron roughneck 151, the PHM 163, the fingerboard 165, and/or the catwalk 131, among other examples. The video cameras 198 generate corresponding video signals (i.e., feeds) comprising or otherwise indicative of the captured digital images. The video cameras 198 may be in signal communication with the processing device 192, such as may permit the video signals to be processed and transmitted to the control workstation 197 and, thus, permit the wellsite operators 195 to view various portions or components of the well construction system 100 on one or more of the output devices 196. The processing device 192 or another portion of the control workstation 197 may be operable to record the video signals generated by the video cameras 198.

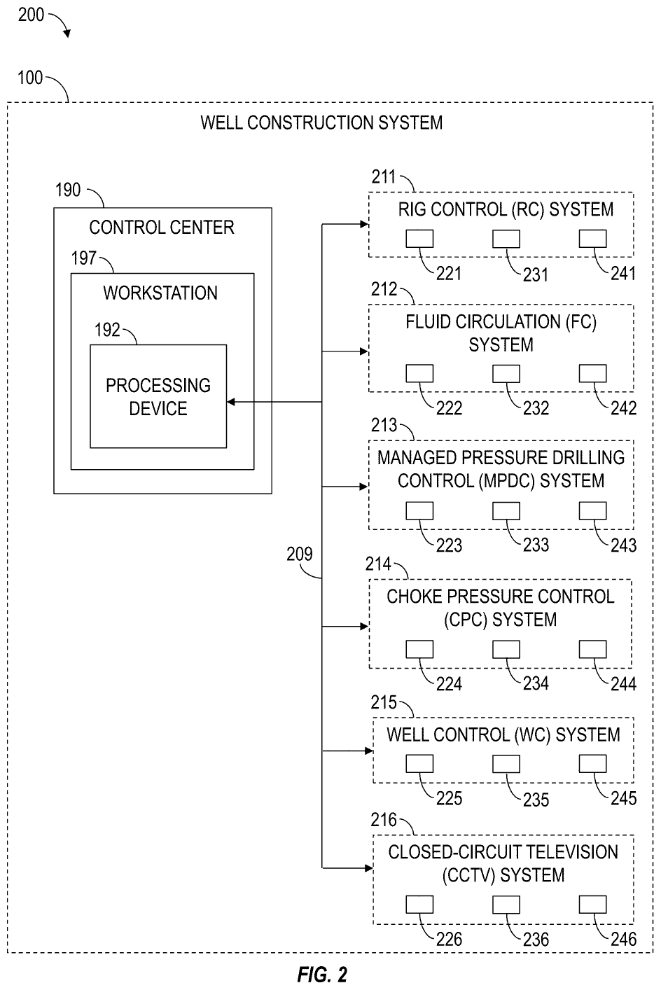

The present disclosure further provides various implementations of systems and/or methods for controlling one or more portions of the well construction system 100. FIG. 2 is a schematic view of at least a portion of an example implementation of a control system 200 for controlling the well construction system 100 according to one or more aspects of the present disclosure. The following description refers to FIGS. 1 and 2, collectively.

The control system 200 may be in real-time communication with and utilized to monitor and/or control various portions, components, and equipment of the well construction system 100 described herein. The equipment of the well construction system 100 may be grouped into several subsystems, each operable to perform a corresponding operation and/or a portion of the well construction operations described herein. The subsystems may include a rig control (RC) system 211, a fluid circulation (FC) system 212, a managed pressure drilling control (MPDC) system 213, a choke pressure control (CPC) system 214, a well pressure control (WC) system 215, and a closed-circuit television (CCTV) system 216. The control workstation 197 may be utilized to monitor, configure, control, and/or otherwise operate one or more of the well construction subsystems 211-216.

The RC system 211 may include the support structure 112, a drill string hoisting system or equipment (e.g., the drawworks 119), a drill string rotational system (e.g., the top drive 116 and/or the rotary table and kelly), the reciprocating slips 161, the drill pipe handling system or equipment (e.g., the catwalk 131, the PHM 163, the fingerboard 165, and the iron roughneck 151), electrical generators, and other equipment. Accordingly, the RC system 211 may perform power generation controls and drill pipe handling, hoisting, and rotation operations. The RC system 211 may also serve as a support platform for drilling equipment and staging ground for rig operations, such as connection make up and break out operations described above. The FC system 212 may include the drilling fluid 140, the pumps 144, drilling fluid loading equipment, the drilling fluid reconditioning equipment 170, the flare stack 172, and/or other fluid control equipment. Accordingly, the FC system 212 may perform fluid operations of the well construction system 100. The MPDC system 213 may include the RCD 138, the choke manifold 162, downhole pressure sensors 186, and/or other equipment. The CPC system 214 may comprise the choke manifold 173, and/or other equipment, and the WC system 215 may comprise the BOP equipment 130, 132, 138, the BOP control unit 137, and a BOP control station (not shown) for controlling the BOP control unit 137. The CCTV system 216 may include the video cameras 198 and corresponding actuators (e.g., motors) for moving or otherwise controlling direction of the video cameras 198. The CCTV system 216 may be utilized to capture real-time video of various portions or subsystems 211-215 of the well construction system 100 and display video signals from the video cameras 198 on the video output devices 196 to display in real-time the various portions or subsystems 211-215. Each of the well construction subsystems 211-216 may further comprise various communication equipment (e.g., modems, network interface cards, etc.) and communication conductors (e.g., cables), communicatively connecting the equipment (e.g., sensors and actuators) of each subsystem 211-216 with the control workstation 197 and/or other equipment. Although the wellsite equipment listed above and shown in FIG. 1 is associated with certain wellsite subsystems 211-216, such associations are merely examples that are not intended to limit or prevent such wellsite equipment from being associated with two or more wellsite subsystems 211-216 and/or different wellsite subsystems 211-216.

The control system 200 may also include various local controllers 221-226 associated with corresponding subsystems 211-216 and/or individual pieces of equipment of the well construction system 100. As described above, each well construction subsystem 211-216 includes various wellsite equipment comprising corresponding actuators 241-246 for performing operations of the well construction system 100. Each subsystem 211-216 further includes various sensors 231-236 for monitoring operational status of the well site equipment of each subsystem 211-216.

The processing device 192 may be communicatively connected with the local controllers 221-226, sensors 231-236, and actuators 241-246. For example, the local controllers may be in communication with the sensors 231-236 and actuators 241-246 of the corresponding subsystems 211-216 via local communication networks (e.g., field buses, not shown) and the processing device 192 may be in communication with the subsystems 211-216 via a communication network 209 (e.g., data bus, a wide-area-network (WAN), a local-area-network (LAN), etc.). Sensor measurement data (e.g., signals, information, etc.) generated by the sensors 231-236 of the subsystems 211-216 may be made available for use by processing device 192 and/or the local controllers 221-226. Similarly, control commands (e.g., signals, information, etc.) generated by the processing device 192 and/or the local controllers 221-226 may be automatically communicated to the various actuators 241-246 of the subsystems 211-216, perhaps pursuant to predetermined programming, such as to facilitate well construction operations and/or other operations described herein.

The sensors 231-236 and actuators 241-246 may be monitored and/or controlled by the processing device 192. For example, the processing device 192 may be operable to receive sensor data from the sensors 231-236 of the wellsite subsystems 211-216 in real-time, and to provide real-time control commands to the actuators 241-246 of the subsystems 211-216 based on the received sensor data. However, certain operations of the actuators 241-246 may be controlled by the local controllers 221-226, which may control the actuators 241-246 based on sensor data received from the sensors 231-236 and/or based on control commands received from the processing device 192.

The processing device 192, the local controllers 221-226, and other controllers or processing devices operable to receive program code instructions and/or sensor data from sensors (e.g., sensors 231-236), process such information, and/or generate control commands to operate controllable equipment (e.g., actuators 241-246) may individually or collectively be referred to hereinafter as equipment controllers. Equipment controllers within the scope of the present disclosure can include, for example, programmable logic controllers (PLCs), industrial computers (IPCs), personal computers (PCs), soft PLCs, variable frequency drives (VFDs) and/or other controllers or processing devices operable to receive sensor data and/or control commands and cause operation of controllable equipment based on such sensor data and/or control commands.

The present disclosure is further directed to selectively positioned video cameras, such as the video cameras 198, and equipment controller(s) operable acquire, process, analyze, and understand digital images of the wellsite equipment captured by the video cameras to determine physical characteristics and/or operational status of wellsite equipment captured by the video cameras. The video cameras may be operable to generate corresponding video signals (i.e., feeds), each comprising the digital images captured by the video camera. The equipment controller(s) may utilize computer vision technology, including machine learning techniques, to help in the well construction operations, such as by automating or changing selected wellsite operations based on the determined physical characteristics and/or operational status. Thus, the present disclosure is further directed to vision systems, such as those comprising one or more portions of the control system 200 and the CCTV system 216, operable to monitor and control selected wellsite equipment of one or more of the well construction subsystems 211-215 of the well construction system 100. The vision systems within the scope of the present disclosure may utilize the video signals generated by the video cameras as feedback to monitor or otherwise determine the physical characteristics and/or operational status of the selected wellsite equipment and control the selected wellsite equipment based on the determined physical characteristics and/or operational status of the wellsite equipment. Such vision systems may be operable to process the digital images captured by the video cameras to, for example, detect edges of an object, determine physical characteristics (e.g., shape, texture) of an object, identify color of an object, and determine orientation of an object with or without tilting, moving, or otherwise adjusting view of the video camera(s). The vision systems within the scope of the present disclosure may be further operable to determine lengths of components or wellsite equipment at the well construction system 100, determine relative position or distance between components or wellsite equipment at the well construction system 100, determine maintenance status of the wellsite equipment, and/or determine HSE compliance at the wellsite.

Vision systems and methods utilizing such vision systems may be implemented, at least in part, via machine learning programs, such as deep neural networks for video and image processing. Such programs may be implemented at different levels of TOT infrastructure, for example at the edge (a resource close to the equipment that can collect, process, and analyze video signals or data) or the Fog (an intermediary stage where data is processed on smart devices like routers and gateways, thereby reducing traffic flow to the cloud and is complementary in nature to cloud computing). However, the video signals generated by video cameras can be pushed straight into the cloud where the video and/or image processing is performed and the machine learning programs are implemented.

Determining Stretch of a Drill Pipe

An example implementation of apparatus and methods according to one or more aspects of the present disclosure may be utilized to measure or otherwise determine the amount of stretch drill pipes experience during drilling and other wellsite operations. Drill pipes can be subjected or otherwise caused to stretch due to the weight of a drill string connected below. Drill pipes can also experience stretching, for example, when the drill string is pulled to determine depth of a stuck point of the drill string.

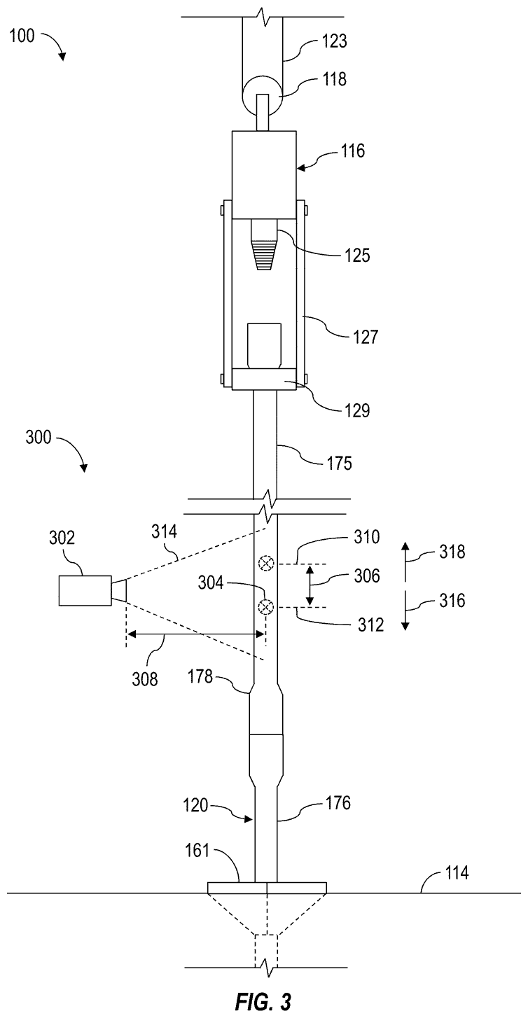

FIG. 3 is a schematic view of at least a portion of an example implementation of a vision system 300 operable to determine the amount of stretch drill pipes experience during drilling and other wellsite operations according to one or more aspects of the present disclosure. The vision system 300 may be a portion of a well construction system, such as the well construction system 100 shown in FIG. 1, and may be disposed or otherwise utilized in association with other portions of the well construction system 100, including where identified by the same numerals. The vision system 300 may be a portion of a control system, such as the control system 200 shown in FIG. 2, and/or a CCTV system, such as the CCTV system 216 shown in FIGS. 1 and 2. Thus, the vision system 300 may be communicatively connected with a processing device, such as the processing device 192 shown in FIGS. 1 and 2. Accordingly, the following description refers to FIGS. 1-3, collectively.

The vision system 300 may comprise a video camera 302 positioned above the rig floor 114 along the support structure 112 and directed or aimed toward a drill pipe 175 (or a stand of drill pipes 175) such that an intended portion of the drill pipe 175 is within a field of view 314 of the camera 302 while the drill pipe 175 is supported by the elevator 129 of the top drive 116 and coupled with another drill pipe 176 extending from the wellbore 102. Such positioning and direction may permit the camera 302 to capture digital images (or video frames) of an intended portion of the drill pipe 175 encompassed within the field of view 314 during drilling and other wellsite operations. The camera 302 may be in signal communication with the processing device 192 of the control system 200. A video signal comprising the captured digital images may be generated by the camera 302 and received by the processing device 192, which may then process and analyze the digital images to determine position and changes in the determined position (i.e., movement) of a visual indicator 304 located on the drill pipe 175 or of a selected portion of the drill pipe 175. The visual indicator 304 may be or comprise one or more visual marks, such as dots, lines, or other two or three dimensional geometric shapes located at predetermined position(s) along the drill pipe 175. The visual indicator 304 may be, for example, imprinted (e.g., painted) onto the drill pipe 175, etched (e.g., carved) into the drill pipe 175, or affixed (e.g., welded) onto the drill pipe 175. The visual indicator 304 may instead be or comprise a physical or otherwise distinguishable feature of the drill pipe 175, such as a shoulder 178 or another portion of a tool joint or upset of the drill pipe 175 that can be captured by the camera 302.

The vision system 300 may be operable to measure or otherwise determine amount of stretch drill pipes experience during drilling and other wellsite operations, such as by identifying and tracking downward movement of the visual indicator 304 between an initial position 310 and a final position 312, as indicated by arrow 316. The vision system 300 may track the movement of the visual indicator 304, for example, by tracking or otherwise determining the quantity (i.e., number) of video pixels the visual indicator 304 moves by within the digital image(s) captured by the camera 302. The determined quantity video pixels may then be converted into physical measurements by utilizing Equation (1).

$$\begin{matrix} \text{?} = ( p \times P ) \times ( \frac{D \times {S}_{h}}{f \times {F}_{h}} ) & ( 1 ) \\ \text{?} \text{indicates text missing or illegible when filed} & \end{matrix}$$

where is change in height 306 of the visual indicator 304, p is the quantity of video pixels between the initial 310 and final 312 positions of the visual indicator 304 on the drill pipe 175, P is the pixel pitch, D is the distance 308 (i.e., working distance) of the visual indicator 304 from the video camera 302, Sₕ is the height of the image sensor (not shown) of the camera 302, f is the focal length of the camera 302, and Fₕ is the frame height of the digital image(s) captured by the camera 302.

Equation (1) may be contained within or captured by program code instructions, which may be executed or otherwise processed by a processing device, such as the processing device 192, to determine the physical change in height 306 of the visual indicator 304. Equation parameters, such as the pixel pitch P, the distance D 308 of the visual indicator 304 from the video camera 302, the height of the image sensor Sₕ of the camera 302, the focal length f of the camera 302, and the frame height Fₕ may be entered into a memory device (e.g., a memory buffer of the processing device) to configure Equation (1) prior to utilizing the vision system 300 during the wellsite operations. During the wellsite operations, the quantity of pixels p between the initial and final positions 310, 312 of the visual indicator 304 may be counted or otherwise determined by the processing device, which may then utilize such information and the entered equation parameters to execute the program code instructions comprising Equation (1) and output the physical change in height 306 of the visual indicator 304.

Determining Depth of a Free Portion of a Stuck Drill String

The vision system 300 may be further operable to determine depth of a free portion (or depth of a stuck portion) of the drill string 120 stuck within the wellbore 102 based on physical change in height 306 of a visual indicator 304. For example, the free point or the point at which the drill string 120 is stuck within the wellbore 102 may be determined by pulling the drill string 120 to the drill string's neutral weight (i.e., the combined weight of the traveling block 118, the top drive 116, and the entire drill string 120). Thereafter, an initial position P₁ 312 of the visual indicator 304 along the drill pipe 175 may be identified or otherwise determined via the video camera 302. The initial position P₁ 312 of the visual indicator 304 may be located at the top of a rotary table or the reciprocating slips 161 along the rig floor 114. An overpull force Fₒ may then be determined based on drill pipe weight per unit length W_{dp} (e.g., pounds per foot) and applied (i.e., pulled) by the hoisting system without exceeding the yield strength of the drill string 120. Application of the overpull force Fₒ may cause the drill string 120 to stretch and the visual indicator 304 to move upwardly, as indicated by arrow 318, to a final or otherwise new position P₂ 310. The initial P₁ 312 and final P₂ 310 positions may be measured with respect to a frame edge of the digital image(s) captured by the camera 302 or a stationary member located within the field of view 314. The amount of stretch S 306 may be determined by utilizing Equation (1) listed above and/or Equation (2).

S=abs(P₂P₁) (2)

After the amount of stretch S 306 is determined, depth of the free point D_{f} of the drill string 120 from the rig floor 114 may be determined via Equation (3).

$${D}_{f} = \frac{{SW}_{d p}}{{F}_{o}} \qquad ( 3 )$$

Similarly as described above with respect to Equation (1), Equations (2) and (3) may be contained within or captured by program code instructions, which may be executed or otherwise processed by a processing device, such as the processing device 192, to determine the depth of the free point D_{f} of the drill string 120. During the wellsite operations, the stretch S 306 of the drill string 120 may be determined based on the initial position P₁ 312 and final position P₂ 310 of the visual indicator 304 and fed to or otherwise saved onto a memory device (e.g., a memory buffer of the processing device). Equation parameters, such as the weight per unit length W_{dp} and overpull Fₒ may also be entered into the memory device. After Equation (3) is configured with each equation parameter, the processing device may execute the program code instructions comprising Equation (3) and output the depth of the free point D_{f} of the stuck drill string 120.

Determining Height of a Drill Pipe from a Rig Floor

An example implementation of apparatus and methods according to one or more aspects of the present disclosure may be utilized to measure or otherwise determine height (i.e., position) of the top of a drill pipe (or stand) from a rig floor after the drill pipe has been raised. Drill pipes are hollow, steel or aluminum alloy piping used on drilling rigs. Each drill pipe comprises a box end (a female threadform), a pin end (male threadform), and a middle tube extending between the box and pin ends. Typically, drill pipes are coupled with each other such that the pin end of the drill pipe is facing or directed downward (i.e., downhole) and the box end is facing or directed upward (i.e., uphole). Depending on the size of a drill rig, two or three drill pipes coupled together may form a drill pipe stand and be handled as a unit for faster drilling operations. Whether the drill rig is tripping or drilling using single drill pipes or stands of drill pipe, the box end is directed upwardly and the pin end is directed downwardly. As described above, to make up a connection between two drill pipes (or stands) on the rig floor, the box end may be latched into an elevator and raised along a mast or derrick to permit a connection to be made between the pin end of a new drill pipe and the box end of a previously connected drill pipe.

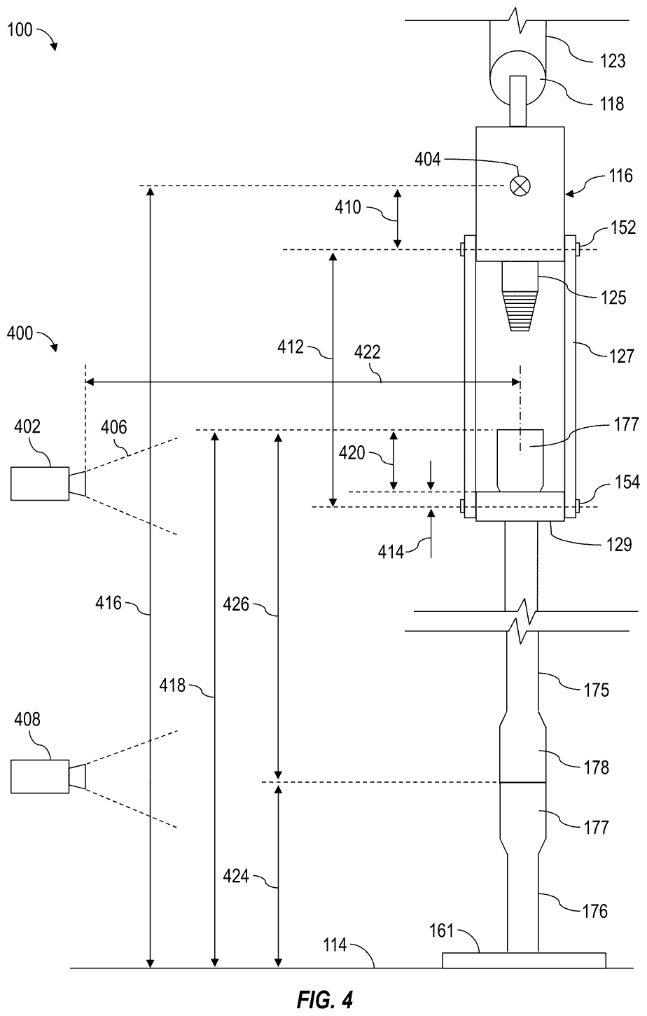

FIG. 4 is a schematic view of at least a portion of an example implementation of a vision system 400 operable to determine the height of the top of a drill pipe (or stand) from a rig floor during drilling and other wellsite operations according to one or more aspects of the present disclosure. The vision system 400 may be a portion of a well construction system, such as the well construction system 100 shown in FIG. 1, and may be disposed or otherwise utilized in association with other portions of the well construction system 100, including where identified by the same numerals. The vision system 400 may be a portion of a control system, such as the control system 200 shown in FIG. 2, and/or a portion of a CCTV system, such as the CCTV system 216 shown in FIGS. 1 and 2. Thus, the vision system 400 may be communicatively connected with a processing device, such as the processing device 192 shown in FIGS. 1 and 2. Accordingly, the following description refers to FIGS. 1, 2, and 4, collectively.

The vision system 400 may comprise a video camera 402 directed or aimed toward the elevator top drive 116 such that a box end 177 of the drill pipe 175 is within the field of view 406 of the camera 402 when the drill pipe 175 is raised. Such positioning and direction may permit the camera 402 to capture digital images (or video frames) of the intended portion of the drill pipe 175 encompassed within the field of view 406 during drilling and other wellsite operations. The camera 402 may be in signal communication with the processing device 192 of the control system 200. A video signal comprising the digital images may be generated by the camera 402 and received by the processing device 192, which may then process and analyze the digital images captured by the camera 402.

By knowing the position and orientation of the camera 402 with respect to the rig floor 114, height 418 of the top of the box end 177 of the drill pipe 175 from the rig floor 114 can be calculated. The height 418 can also or instead be calculated using a block position, which may be or comprise the height above the rig floor 114 of a predetermined reference point located at a known position on the traveling block 118 or the top drive 116. The block position may be determined, for example, by measuring the quantity (i.e., number) of rotations of the drawworks 119, such as with an encoder, and calculating the length of support line 123 that is spooled out with the movement of the drawworks 119. The block position may be at a known distance from the bottom of the elevator 116, such that the distance between the bottom of the elevator 116 and the rig floor 114 is also known.

The block position may be a height or position of a visual mark or indicator 404 on the top drive 116 or travelling block 118 and indicated by distance Pb 416 above the rig floor 114. Distance lₐ 410 between upper eyes 152 of the tubular handling assembly links 127 and the visual indicator 404 may be known or determined based on manufacturing drawings or by physically measuring such distance. Similarly, distance l_{b} 412 between the upper eyes and lower eyes 154 may be known or determined based on manufacturer drawings of the elevator links 127 or by physically measuring such distance. Distance l_{c} 414 between the lower eyes 154 and top of the elevator 129 may be known or determined based on manufacturer drawings of the elevator 129 or by physically measuring such distance. Distance T_{b} 418 between the top of the box end 177 of the drill pipe 175 and the drill floor 114 may then be determined by utilizing Equation (4).

T_{b}=(P_{b}+((l_{c}+l_{d})(lₐ+l_{b}))) (4)

The visual system 400 may be utilized to determine distance l_{d} 420 of the top of the box end 177 of the drill pipe 175 above the elevator 129, which may then permit Equation (4) to be solved to determine the distance T_{b} 418. For example, the vision system 400 may determine the distance l_{d} 420 by counting or otherwise determining the quantity of video pixels between the top of the drill pipe 175 and the top of the elevator 129. The video pixels may be converted into physical measurements by utilizing Equation (5).

$${l}_{d} = ( {P}_{i} ) \times ( \frac{D \times {S}_{h}}{f \times {F}_{h}} ) \qquad ( 5 )$$

where Pᵢ is the pixel size (e.g., quantity of pixels) spanning between the top of the drill pipe 175 and the top of the elevator 129, D is a radial distance 422 (i.e., working distance) of the drill pipe 175 from the camera 402, Sₕ is the height of the image sensor of the camera 402, f is the focal length of the camera 402, and Fₕ is a frame height of the digital image(s) captured by the camera 402.

Although the visual indicator 404 is shown located on a main body or upper portion of the top drive 116, the visual indicator 404 may be located on other portions of the top drive 116 or on the travelling block 118. Furthermore, portions of the top drive 116 or the travelling block 118 may also or instead be utilized as a visual indicator or reference point for measuring relative distances. For example, the bottom (edge) of the elevator 116 may be utilized as a reference point to compute or otherwise determine the length of the drill pipe 175 above the elevator 116. Also, instead of utilizing manufacturer drawings of the top drive 116, the various distances lₐ 410, l_{b} 412, and l_{c} 414 may be determined by the vision system 400 by counting or otherwise determining the quantity of video pixels between the features defining such distances.

After the distance T_{b} 418 of the top of the box end 177 of the drill pipe 175 from the rig floor 114 can be continually tracked such that the drilling or tripping of the drill pipe 175 (or a stand) is completed, resulting in an intended (e.g., constant) stick up distance 424 from the rig floor 114. The stick up distance 424 may be governed by the height of tongs or the height of the torqueing portions 153 of the iron roughneck 151 such that the connection can be made between the drill pipe 176 that was just drilled or tripped and the new drill pipe 175 that was lifted by the hoisting system. The control system 200 of the well construction system 100 may be utilized to control movement of the top drive 116 during drilling and tripping operations such that the stick up distance 424 from the rig floor 114 is substantially constant and repeatable. Another video camera 408 may also be directed at the box end 177 of the drill pipe 176 at the rig floor 114 to measure the stick up distance 424 in a similar manner at the camera 402 is utilized to measure the distance T_{b} 418 of the drill pipe 175.

Similarly as described above with respect to Equations (1) and (2), Equations (4) and (5) may be contained within or captured by program code instructions, which may be executed or otherwise processed by a processing device, such as the processing device 192. During the wellsite operations Equation (5) may be utilized to determine the distance l_{d} 420 based on the previously entered equation parameters radial distance D 422, the height of the image sensor Sₕ, the focal length f, and the frame height Fₕ, and the determined pixel size P. The determined distance lₐ 420 may be saved onto a memory device (e.g., a memory buffer of the processing device) and utilized along with the previously entered distances lₐ 410, l_{b} 412, l_{c} 414, and T_{b} 418 to determine the distance T_{b} 418.

When the well construction system 100 causes the stick up distance 424 to be maintained at a constant known level during drilling or tripping operations, the length 426 of each drill pipe 175 going into the drill string 120 can then be determined by subtracting the known stick up distance 424 from the previously determined distance T_{b} 418 of the top of the drill pipe 175 from the rig floor 114. Furthermore, although the vision systems 300 and 400 are shown and described above being utilized during drilling and drill pipe tripping operations, the vision systems 300 and 400 and operations described herein may be utilized to measure lengths and distances not just of drill pipes 175 and stands of drill pipes 175, but also to measure lengths and distances of other tubulars, such as casing joints, that may be tripped downhole.

### Determining Casing Alignment During Casing Running Operations

After a wellbore is drilled, a casing string may be ran into the wellbore and cemented therein to protect the wellbore from damage over time. Each casing joint (tubular) is threaded, such as may facilitate connection between adjacent casing joints to assemble the casing string. During casing running operations, new casing joints are coupled with the casing string that is assembled in the wellbore. The top of the casing string may be locked in position or engaged by a set of slips to prevent the casing string from falling into the wellbore. To make up a connection on the rig floor, the lower end of the casing joint suspended above the rig floor by a hoisting system is aligned with the upper end of the casing string projecting from the wellbore and then rotated with tongs. Such alignment may be performed manually or with a casing alignment tool (or a casing running tool). Each alignment has to be properly performed, as misalignment can cause cross threading that can damage the threads and prevent a fluid seal from forming between the casing joints. High pressure and heat within a well may cause an improperly formed fluid seal to lose integrity or fail.

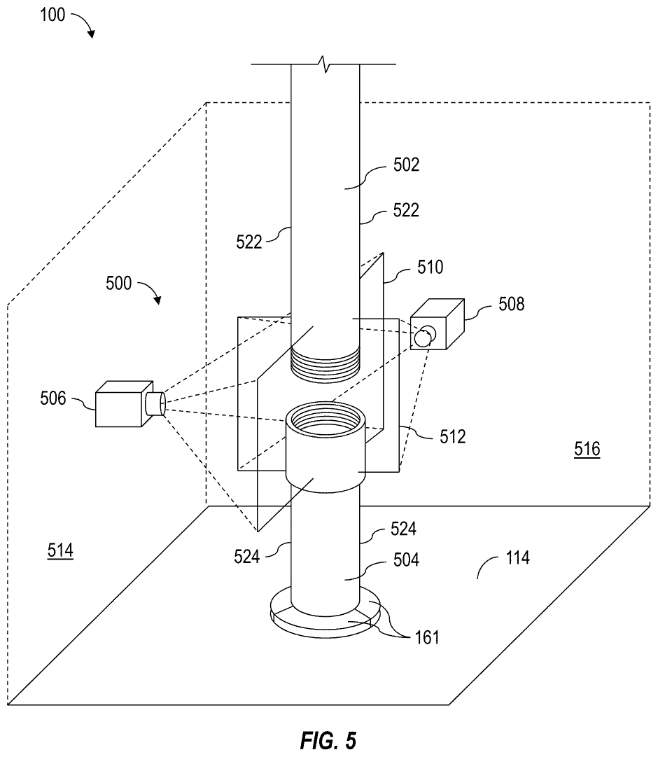

FIG. 5 is a schematic view of at least a portion of an example implementation of a vision system 500 operable to monitor or otherwise determine alignment of a new casing joint 502 with respect to a casing joint 504 previously coupled with the casing string and extending from a wellbore during casing running operations according to one or more aspects of the present disclosure. Although the vision system 500 is shown utilized to monitor alignment of casing joints, it is to be understood that the vision system 500 may be utilized to monitor alignment of other tubulars, such as drill pipe, drill collars, pup joints, and production tubing, among other examples.

The vision system 500 may be a portion of a well construction system, such as the well construction system 100 shown in FIG. 1, and may be disposed or otherwise utilized in association with other portions of the well construction system 100, including where identified by the same numerals. The vision system 500 may be a portion of a control system, such as the control system 200 shown in FIG. 2, and/or a portion of a CCTV system, such as the CCTV system 216 shown in FIGS. 1 and 2. Thus, the vision system 500 may be communicatively connected with a processing device, such as the processing device 192 shown in FIGS. 1 and 2. Accordingly, the following description refers to FIGS. 1, 2, and 5, collectively.

The vision system 500 may comprise video cameras 506, 508 directed or aimed toward the casing joints 502, 504 to capture the pin and box ends of the casing joints 502, 504, respectively, within corresponding fields of view 510, 512 of the cameras 506, 508 while the upper (new) casing joint 502 approaches the lower (previously connected) casing joint 504. The cameras 506, 508 may be positioned or directed along different (e.g., perpendicular) planes 514, 516 such that the corresponding fields of view 510, 512 extend along different planes. Such positioning and direction may permit the cameras 506, 508 to capture digital images (or video frames) of the pin and box ends of the casing joints 502, 504 encompassed within the fields of view 510, 512 from different (e.g., perpendicular) angles during casing running operations. The cameras 506, 508 may be in signal communication with the processing device 192 of the control system 200. A video signal comprising the captured digital images may be generated by each camera 506, 508 and received by the processing device 192, which may then process and analyze the digital images. For example, the vision system 500 may be operable to process and analyze the digital images to determine presence and/or amount of misalignment between the pin end of the upper casing joint 502 and the box end of the lower casing joint 504. The vision system 500 may be operable to detect relative positions (e.g., relative distances) of the casing joints 502, 504, such as by detecting relative positions of edge(s) 522 of the pin end of the casing joint 502 with respect to edge(s) 524 of the box end of the casing joint 504, and determining if the edges 522, 524 are substantially aligned with each other along the horizontal axes within the digital images captured by the cameras 506, 508 to permit proper threaded engagement between the casing joints 502, 504. The edges 522, 524 of the casing joints 502, 504 may be or comprise opposing edges of profiles of the casing joints 502, 504 in the digital images.

Horizontal distances between the edge(s) 522 of the pin end of the upper casing joint 502 and the edge(s) 524 of the box end of the lower casing joint 504 may be determined, for example, by tracking quantity of pixels spanning between the edges 522, 524 of the pin and box ends of the casing joints 502, 504 along corresponding horizontal axes in the digital images captured by the cameras 506, 508. The tracked quantity of pixels for each digital image may then be converted to physical dimensions to determine actual horizontal distances between edges 522, 524 of the casing joints 502, 504, such as by utilizing one or more of Equations (1) and (5). The vision system 500 may also measure amount of misalignment, such as based on video pixel tracking. The misalignment measurements performed by the vision system 500 may be utilized to automatically initiate a visual and/or audio alarm when misalignment exists between the pin end of the upper casing joint 502 and the box end of the lower casing joint 504 or if the determined amount of misalignment exceeds a predetermined threshold. The misalignment measurements performed by the vision system 500 may also or instead be utilized as feedback to the control system 200 to automatically and in real-time cause one or more portions of the RC system 211 to adjust the position of the casing joint 502 to substantially align the casing joint 502 with the casing joint 504.

Determining Position of the Travelling Block

A crown saving system may be utilized to prevent the traveling block from hitting the crown block during tubular raising operations. The crown saving system may include block position control via the drill rig control system and may utilize proximity sensors on the drill rig support structure (e.g., mast) and/or mechanical toggle valves on the drawworks. The drill rig control system may receive block position measurements computed from an encoder on the shaft of the drawworks to determine position of the traveling block with respect to the crown block. Use of the encoder and/or proximity sensors permits the slowing down of the traveling block before it comes to a complete stop. Use of the mechanical toggle, however, causes sudden locking down of mechanical brakes via pneumatic cylinders.

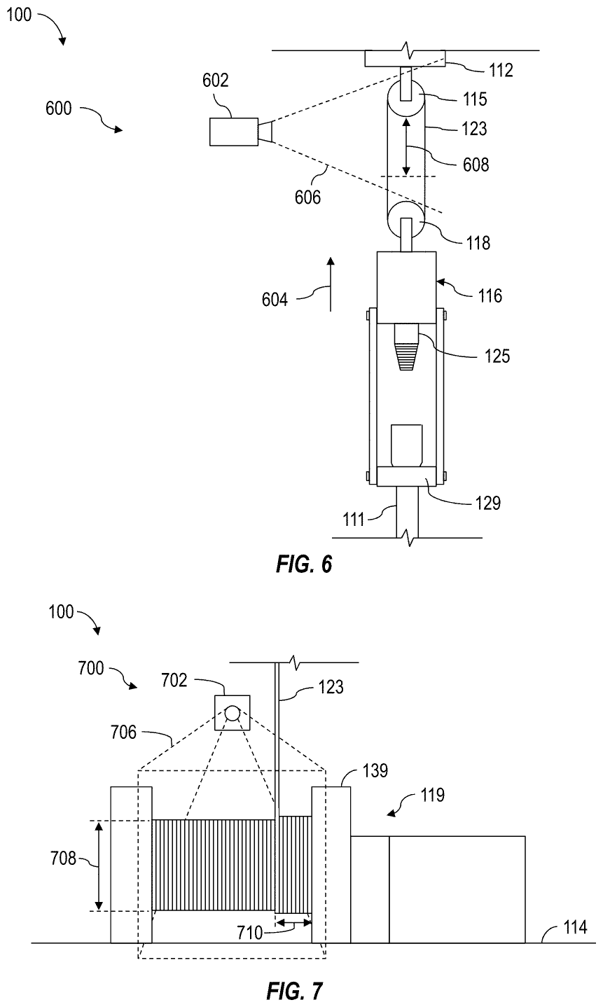

FIGS. 6 and 7 are schematic views of at least a portion of example implementations of vision systems 600, 700 operable to monitor or otherwise determine and control vertical position of a traveling block with respect to a crown block during tubular lifting and/or lowering operation according to one or more aspects of the present disclosure. The vision systems 600, 700 may each be a portion of a well construction system, such as the well construction system 100 shown in FIG. 1, and disposed or otherwise utilized in association with other portions of the well construction system 100, including where identified by the same numerals. The vision systems 600, 700 may each be a portion of a control system, such as the control system 200 shown in FIG. 2, and/or a CCTV system, such as the CCTV system 216 shown in FIGS. 1 and 2. Thus, the vision systems 600, 700 may each be communicatively connected with a processing device, such as the processing device 192 shown in FIGS. 1 and 2. Accordingly, the following description refers to FIGS. 1, 2, 6, and 7, collectively.

The vision system 600 may comprise a video camera 602 directed toward the crown block 115 such that at least a portion of the crown block 115 is within the field of view 606 of the camera 602 while the traveling block 118 and the top drive 116 are moved vertically, such as during drilling or other wellsite operations. Such positioning and direction may permit the camera 602 to capture digital images (or video frames) of the crown block 115 and the travelling block 118 encompassed within the field of view 606 when the traveling block 118 is near the crown block 115. The camera 602 may be in signal communication with the processing device 192 of the control system 200. A video signal comprising the captured digital images may be generated by the camera 602 and received by the processing device 192, which may then process and analyze the digital images to determine relative position between the crown block 115 and the travelling block 118 and prevent the traveling block 118 from hitting the crown block 115 when the traveling block 118 moves upward, as indicated by arrow 604. Such operation may be achieved by setting one or multiple threshold distances 608 of the travelling block 118 from the crown block 115, which when crossed by the traveling block 118, may cause a controlled movement or a complete stop of the traveling block 118.

Vertical distance between the crown block 115 and the traveling block 118 may be determined, for example, by tracking quantity of pixels spanning between the crown block 115 and the traveling block 118 in the digital images while the traveling block 118 is moving. The determined quantity of pixels in each digital image may then be converted to physical dimensions to determine actual vertical distances between the crown block 115 and the traveling block 118, such as by utilizing one or more of Equations (1) and (5). The vertical distance measurements performed by the vision system 600 may be utilized as real-time feedback to the control system 200 to automatically initiate slowdown or stop operations of the traveling block 118 when the traveling block 118 is within the threshold distance 608 from the crown block 115. The vison system 600 may implement a machine learning model to train the vision system 600 to identify the top of the traveling block or the top drive 116 (or another portion of the traveling block 118 or top drive 116) against which the position threshold 608 can be set.

The vision system 700 may comprise a video camera 702 directed toward the drawworks 119 such that a drum 139 of the drawworks 119 is within the field of view 706 of the camera 702 while the drawworks 119 winds and unwinds the support line 123 during drilling or other wellsite operations. Such positioning and direction may permit the camera 702 to capture digital images (or video frames) of the drum 139 and the support line 123 wrapped around the drum 139 encompassed within the field of view 706 during operations. The camera 702 may be in signal communication with the processing device 192 of the control system 200. A video signal comprising the capture digital images may be generated by the camera 702 and received by the processing device 192, which may then process and analyze the digital images to monitor or otherwise determine the amount of support line 123 wrapped on the drum 139.

The support line 123 may be anchored on one side of the drum 139 and each loop (i.e., wrap) of the support line 123 moves sequentially to the opposite side of the drum 139. At the end of one layer of the support line 123, direction of wrapping changes to start forming another layer of the support line 123. A threshold of height 708 of completed support line layers on the drum 139 and/or a threshold of width 710 of an unfinished layer of the support line 123 being formed on the drum 139 may be set to prevent the traveling block 118 from hitting the crown block 115 when the traveling block 118 moves upward 604. Either through calculations, physically checking, and/or machine learning, the threshold height 708 and width 710 of the support line 123 can be set to or otherwise associated with a safety threshold distance (such as the threshold distance 608 shown in FIG. 6) between the traveling block 118 and the crown block 115. Machine learning may be utilized to train to identify, for example, the support line 123 and keep track of the quantity of loops and layers of the support line 123 around the drum 139 to determine the length of the support line 123 wrapped around the drum 139, which may be utilized to determine the distance between the traveling block 118 and the crown block 115. The support line 123 may be or comprise a cable or wire rope comprising strands of metal wire twisted (laid) into a helix. The support line 123 can be identified by identifying one or more of its features, such as the quantity and pattern of wire strands, identifying construction (e.g., lay) of the support line 123, and/or by identifying the contour of the support line 123. Thus, when a threshold 708 is triggered, the vision system 700 may then cause a controlled movement or complete stop of the traveling block 118.

The height 708 and width 710 of the support line 123 wrapped around the drum 139 may be determined, for example, by tracking quantity of pixels spanning the height 708 and the width 710 in the digital images while the drum 139 rotates. The determined quantity of pixels in each digital image may then be converted to physical dimensions to determine the amount of support line 123 on the drum 139 and, thus, the actual vertical distances between the crown block 115 and the traveling block 118, such as by utilizing one or more of Equations (1) and (5). The measurements performed by the vision system 700 may be utilized as real-time feedback to the control system 200 to automatically initiate slowdown or stop operations of the traveling block 118 when the traveling block 118 is within the threshold distance from the crown block 115.

### Determining Orientation of Tubulars During Make-Up Operations

During some well construction operations, such as directional drilling with a downhole motor, a bent sub or housing of such motor may be used for steering (i.e., guiding) a drill bit in a predetermined (i.e., planned) azimuthal direction. The downhole motor may be steered in an intended azimuthal direction, for example, by controlling azimuthal (i.e., angular) orientation of an obtuse angle of the bent sub or housing with respect to the high side (i.e., side of the wellbore opposite to the direction of gravity) of the wellbore. The azimuthal orientation of the bent sub or housing may be set at the wellsite surface before subsequent downhole tools are run downhole. The azimuthal orientation may be maintained during make up operations, for example, by arresting or otherwise preventing rotation of the drill string when it is run downhole. Azimuthal orientation between the bent sub or housing and a downhole tool may be monitored or otherwise tracked, for example, if a magnetic sensor for measuring the azimuthal orientation of the bent sub or housing is located close to magnetic material (e.g., casing material) that interferes with measurements.

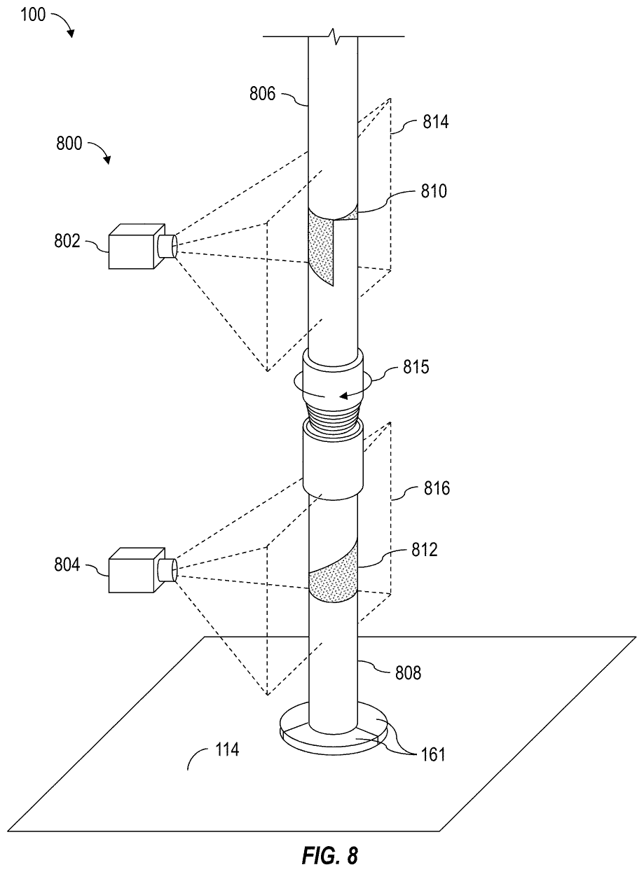

FIG. 8 is a schematic view of at least a portion of an example implementation of a vision system 800 operable to determine (e.g., monitor, track) azimuthal orientation of downhole tubulars while downhole by determining the azimuthal orientation of the downhole tubulars at the wellsite surface while the downhole tubulars are run into the wellbore. The vision system 800 may be a portion of a well construction system, such as the well construction system 100 shown in FIG. 1, and may be disposed or otherwise utilized in association with other portions of the well construction system 100, including where identified by the same numerals. The vision system 800 may be a portion of a control system, such as the control system 200 shown in FIG. 2, and/or a portion of a CCTV system, such as the CCTV system 216 shown in FIGS. 1 and 2. Thus, the vision system 800 may be communicatively connected with a processing device, such as the processing device 192 shown in FIGS. 1 and 2. Accordingly, the following description refers to FIGS. 1, 2, and 8, collectively.

The vision system 800 may comprise video cameras 802, 804, each directed or aimed toward a corresponding downhole tubular 806, 808 (e.g., mud motor, downhole tools, drill pipe, casing joints, etc.) being made up just above the rig floor 114 and deployed within the wellbore. Each downhole tubular 806, 808 that is made up and conveyed downhole, may be marked by, carry, or otherwise comprise one or more geometric patterns 810, 812 imparted onto an outer surface of the downhole tubular 806, 808. The lower camera 804 may be directed toward the lower tubular 808 to capture the geometric pattern 812 of the lower tubular 808 within the field of view 816 of the lower camera 804 while the lower tubular 808 is locked in position and suspended within the wellbore via the reciprocating slips 161. The upper camera 802 may be directed toward the upper tubular 806 to capture the geometric pattern 810 of the upper tubular 806 within the field of view 814 of the upper camera 802 while the upper tubular is being rotated, as indicated by arrow 815, to make up a connection with the lower tubular 808. Each camera 802, 804 may capture digital images (or video frames) of the corresponding downhole tubular 806, 808 and geometric pattern 810, 812 encompassed within its field of view 814, 816. The cameras 802, 804 may be in signal communication with the processing device 192 of the control system 200. Each camera 802, 804 may be further operable to generate a corresponding video signal comprising the captured digital images, which may be received, processed, and analyzed by the processing device 192 to determine the azimuthal orientation of each downhole tubular 806, 808 based on the geometric pattern 810, 812 captured in the digital images.

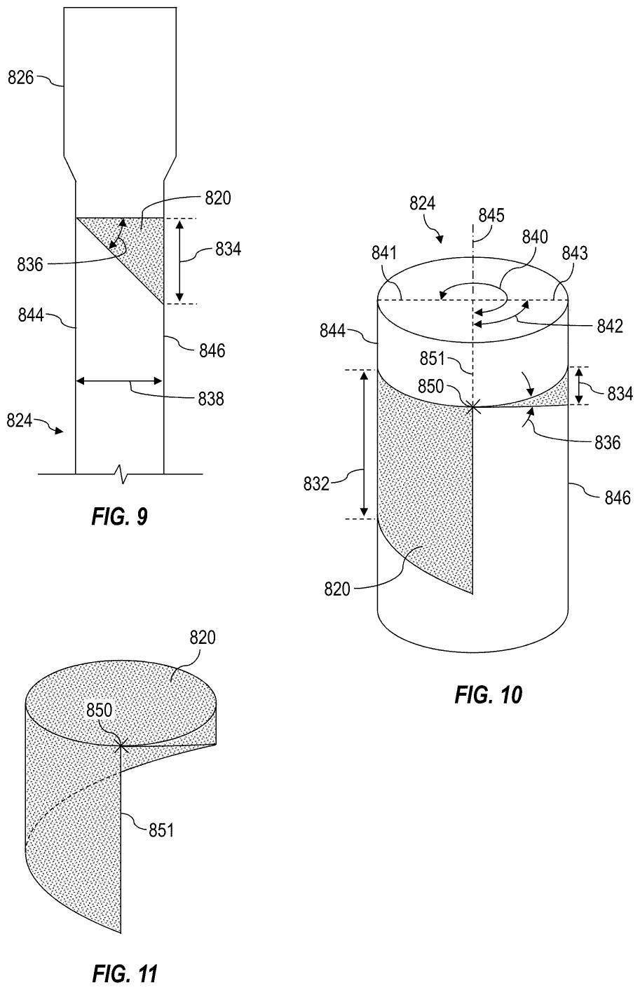

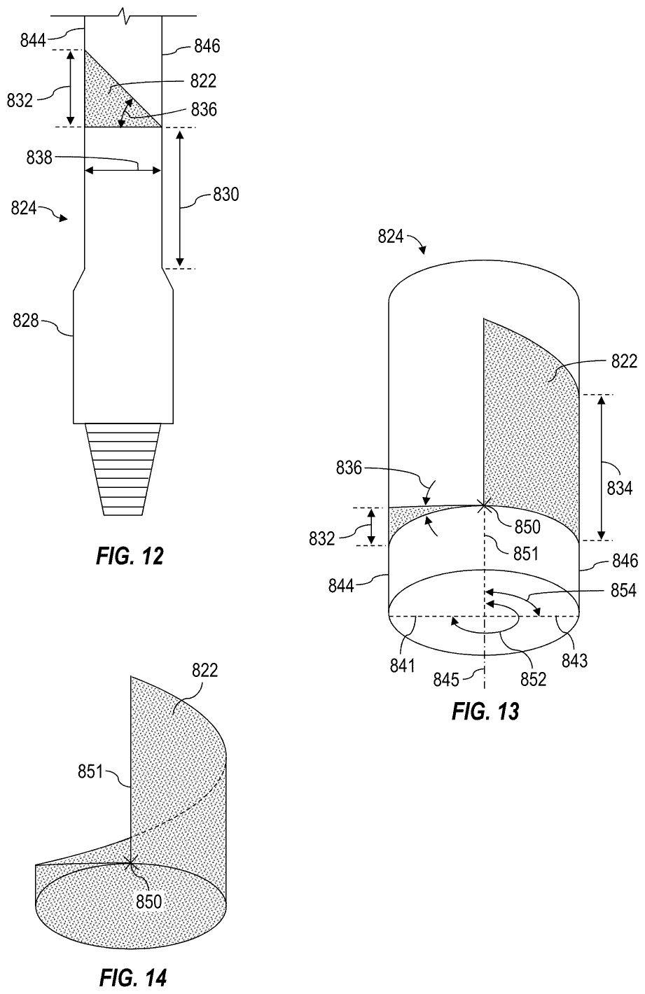

FIG. 9 is a side view of a box end 826 of a downhole tubular 824 (e.g., downhole tool, drill pipe, casing joint, etc.) comprising an example implementation of a geometric pattern 820 according to one or more aspects of the present disclosure. FIG. 10 is a perspective view of a portion of the downhole tubular 824 shown in FIG. 9 comprising the geometric pattern 820. FIG. 11 is a perspective view of the geometric pattern 820 shown in FIG. 10, but shown without the tubular 824 for clarity and ease of understanding. FIG. 12 is a side view of a pin end 828 of the downhole tubular 824 comprising an example implementation of a geometric pattern 822 according to one or more aspects of the present disclosure. FIG. 13 is a perspective view of a portion of the downhole tubular 824 shown in FIG. 12 comprising the geometric pattern 822. FIG. 14 is a perspective view of the geometric pattern 822 shown in FIG. 13, but shown without the tubular 824 for clarity and ease of understanding. The following description refers to FIGS. 1, 2, and 8-14, collectively.

The geometric pattern 820 may be imparted onto an outer surface of the tubular 824 near or adjacent the box end 826 of the tubular 824 such that the camera 804 can capture the geometric pattern 820 within its field of view 816 while the tubular 824 is locked in position and suspended within the wellbore 102. The geometric pattern 822 may be imparted onto the outer surface of the tubular 824 near or adjacent the pin end 828 of the tubular 824 such that the camera 802 can capture the geometric pattern 822 within its field of view 814 while the tubular 824 is being rotated to make up a connection with a previously connected tubular suspended within the wellbore. The geometric pattern 820 may be located at a close distance to the box end 826, such that the geometric pattern 820 is above the rig floor 114 and can be viewed by the camera 804 when the tubular 824 is suspended within the wellbore 102 via the slips 161. The geometric pattern 822 may be located at a predetermined distance 830 from the pin end 828, such as to permit tongs or another mechanical wrench to rotate the tubular 824 without obstructing the camera's 802 view of the geometric pattern 822.

Each geometric pattern 820, 822 may wrap or otherwise extend around the tubular 824. Each geometric pattern 820, 822 may be or comprise a surface finish or a plurality of two or three dimensional visual marks (e.g., dots, lines) arranged in a predetermined geometric pattern or shape. Each geometric pattern 820, 822 may be, for example, imprinted (e.g., painted) onto the outer surface of the tubular 824, etched (e.g., carved) into the outer surface of the tubular 824, or affixed (e.g., welded) onto the outer surface of the tubular 824. The surface finish forming the geometric patterns 820, 822 may be or comprise surface polish having a high reflective co-efficient. However, one of the geometric patterns 820, 822 may comprise a higher reflective coefficient and the other of the geometric patterns 820, 822 may comprise a lower reflective coefficient. The difference in the surface finish may cause difference in coefficient of friction or adhesion of mud that may be perceived or identified by the cameras 802, 804 when the tubular 824 is covered in mud. The geometric pattern 820 associated with the box end 826 of the tubular 824 may be or comprise a different geometric shape than the geometric pattern 822 associated with the pin end 826 of the tubular 824. The geometric patterns 820, 822 may be or comprise the same, but reversed or inverted geometric shapes. Example implementation of the geometric patterns 820, 822 may be or comprise a triangle (e.g., a right triangle, an isosceles triangle, etc.) wrapped or extending around the outer surface of the tubular 824. However, the geometric patterns 820, 822 may be or comprise other geometric shapes having a changing vertical dimension (e.g., height, width, length, etc.) while the tubular 824 rotates.

The vision system 800 may be operable to capture and process digital images of the geometric patterns 820, 822 to track (i.e., monitor) or otherwise determine azimuthal orientations of downhole tubulars 824 by determining azimuthal orientations of the geometric patterns 820, 822 while the tubulars 824 are made up at the rig floor 114. For example, the vision system 800 may be operable to determine vertical lengths 832, 834 of the geometric patterns 820, 822 along one or both edges 844, 846 of each tubular 824 being made up to determine the azimuthal orientation of each geometric pattern 820, 822 and, thus, the azimuthal orientation of each tubular 824 being made up. The edges 844, 846 of the tubular 824 may be or comprise opposing edges of the profile of the tubular 824 in the digital images captured by the cameras 802, 804. Each edge 844, 846 may be associated with a corresponding edge line 841, 843 extending between a central axis 845 (i.e., axis of rotation) of the tubular 824 and the corresponding edge 844, 846. The lengths 832, 834 of the geometric patterns 820, 822 along the edges 844, 846 of the tubular 824 change by a known amount while the tubular 824 is rotated. Thus, by determining the lengths 832, 834 of the geometric patterns 820, 822, the azimuthal orientation of the geometric patterns 820, 822 and, thus, of the tubulars 824 can be determined. The lengths 832, 834 of the geometric patterns 820, 822 along the edges 844, 846 of the tubulars 824 may be determined, for example, by tracking the quantity of vertical pixels spanning across the geometric patterns 820, 822 along the edges 844, 846 of the tubulars 824 in the digital images captured by the cameras 802, 804. The determined quantity of pixels spanning across the geometric patterns 820, 822 along the edges 844, 846 of the tubulars 824 may then be converted to physical lengths.

Azimuthal orientation of the tubular 824 may be, comprise, or be based on the azimuthal orientation of each edge line 841, 843 with respect to a reference point 850 or line 851 of the geometric pattern 820, which may be determined by utilizing equations (6) and (7).

$${θ}_{1} = \frac{{l}_{1} \times 2}{tan ( ∝ ) \times D} \qquad ( 6 )$$

where l₁ is the length 832 of the geometric pattern 820 along the left edge 844 of the tubular 824, ∂ is the angle 836 of the geometric pattern edge, D is the diameter 838 of the tubular 824, and θ₁ is the azimuthal orientation 840 of the left edge line 841 with respect to the reference point 850 or line 851 of the geometric pattern 820 at the box end 826 of the tubular 824.

$${θ}_{2} = \frac{{l}_{2} \times 2}{tan ( ∝ ) \times D} \qquad ( 7 )$$

where l₂ is the length 834 of the geometric pattern 820 along the right edge 846 of the tubular 824, ∂ is the angle 836 of the geometric pattern edge, D is the diameter 838 of the tubular, and θ₂ is the azimuthal orientation 842 of the right edge line 843 with respect to the reference point 850 or line 851 of the geometric pattern 820 at the box end of the tubular 824. Azimuthal orientation O_{pb} of the box end 826 (pipe-box end) of the tubular 824 may be or comprise the azimuthal orientation θ₁ 840 or the azimuthal orientation θ₂ 842, as indicated by Equation (8).

O_{pb}=(θ₁;θ₂) (8)

Equations (6) and (7) may also be utilized to determine azimuthal orientations θ₃ 852 and θ₄ 854 of the left and right edge lines 841, 843 with respect to the reference point 850 or line 851 of the geometric pattern 822 at the pin end 828 of the tubular 824. Azimuthal orientation Oₚₚ of the pin end 828 (pipe-pin end) of the tubular 824 may be or comprise the azimuthal orientation θ₃ 852 and the azimuthal orientation θ₄ 854, as indicated by Equation (9).

Oₚₚ=(θ₃;θ₄) (9)

Azimuthal orientation offset O_{OL} between the reference point 850 or line 851 of the geometric pattern 820 at the box end 826 of the tubular 824 and the reference point 850 or line 851 of the geometric pattern 822 at the pin end 828 of the tubular 824 measured with respect to the left edge line 841 of the tubular 824 may be determined by utilizing equation (10).

O_{OL}=(θ₁θ₃) (10)

The azimuthal orientation offset O_{OR} between the reference point 850 or line 851 of the geometric pattern 820 at the box end 826 of the tubular 824 and the reference point 850 or line 851 of the geometric pattern 822 at the pin end 828 of the tubular 824 measured with respect to the right edge line 843 of the tubular 824 may be determined by utilizing equation (11).

O_{OR}=(θ₂θ₄) (11)

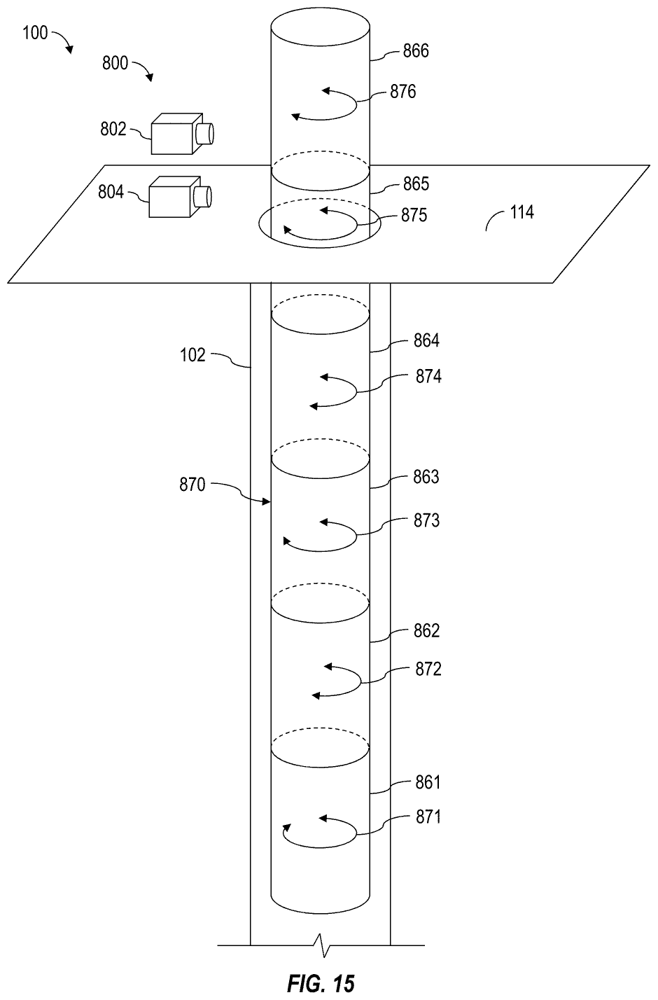

FIG. 15 is another schematic view of at least a portion of the vision system 800 shown in FIG. 8 and operable to track, monitor, or otherwise determine azimuthal orientations (O_{pb} and/or Oₚₚ) of downhole tubulars while downhole by monitoring the azimuthal orientation of the downhole tubulars at the wellsite surface while the downhole tubulars are run into the wellbore 102. The following description refers to FIGS. 8-15, collectively.

During tubular string assembly operations (e.g., drilling operations, drill pipe running operations, casing running operations, etc.) current (i.e., present) azimuthal orientation 871 of a first tubular 861 (e.g., mud motor, a BHA sub, casing joint, etc.) of a tubular string 870 (e.g., drilling string, casing string, etc.) may be determined based on the azimuthal orientation of a geometric pattern (e.g., geometric pattern 820, 822) (not shown in FIG. 15) on the first tubular 861 with respect to left or right edge of the first tubular 861 while the first tubular 861 is inserted into the wellbore 102. Azimuthal orientations 872-876 of each subsequent tubular 862-866 coupled above the first (e.g., lowermost) tubular 861 may also be determined based on azimuthal orientations of geometric patterns on the subsequent tubulars 862-866 with respect to left or right edges of the subsequent tubulars 862-866 while each subsequent tubular 862-866 is coupled with a previously coupled tubular. By tracking the azimuthal orientation of each subsequent tubular 862-866, the current azimuthal orientation of the first tubular 861 and/or another previously coupled tubular (e.g., sensor sub) with respect to a newly coupled tubular 866 or otherwise with respect to another reference (e.g., rig floor) can be tracked or otherwise determined.

The azimuthal orientation of a selected tubular of the tubular string 870 with respect to left or right edge (or another reference point) of the newly coupled tubular 866 may be determined by aggregating or totaling the azimuthal orientations of the selected tubular and the tubulars coupled above the selected tubular. If an azimuthal orientation offset (e.g., O_{OL} or O_{OR}) exists between the box end 826 geometric pattern and the pin end 826 geometric pattern of one or more of the tubulars 862-866, then such offset may be aggregated with the azimuthal orientations 872-876 of the tubulars 862-866 to determine the current azimuthal orientation of the first tubular 861 and/or another selected tubular.

Azimuthal orientation of each new tubular (tubular 866 in FIG. 15) being coupled with the previously coupled tubular (tubular 865 in FIG. 15) during tubular string assembly operations may be tracked via the upper camera 802 by tracking the orientation of the lower geometric pattern located adjacent the pin end of the new tubular. Although the tool string 870 is locked in position by reciprocating slips or another device, during tubular string assembly operations the tool string 870 may slip or otherwise slightly rotate, such as when the new tubular is tightened against the previously coupled tubular and/or when the tubular string 870 (including the coupled new tubular) is moved downhole. Accordingly, azimuthal orientation of each previously coupled tubular during tubular string assembly operations may be tracked or confirmed via the lower camera 804 by tracking the orientation of the upper geometric pattern located adjacent the box end of the previously coupled tubular.

Similarly as described above with respect to Equations (1)-(5), Equations (6)-(11) may be contained within or captured by program code instructions, which may be executed or otherwise processed by a processing device, such as the processing device 192. During the wellsite operations, Equations (6) and (7) may be utilized to determine the azimuthal orientations θ₁ 840, θ₂ 842, θ₃ 852, θ₄ 854 based on the previously entered equation parameters, such as the angle ∂ 836 of the geometric pattern edge, the diameter D 838 of the tubular 880, and the measured lengths l₁ 832 and l₂ 834 of the geometric patterns 820, 822. The determined azimuthal orientations θ₁ 840, θ₂ 842, θ₃ 852, θ₄ 854 for each tubular connected to a tubular string may be saved onto a memory device (e.g., a memory buffer of the processing device). The determined azimuthal orientations may then be aggregated to determine the current orientation of the first 861 (i.e., bottom) or another 862-865 tubular along the tubular string 870 with respect to the last (i.e., uppermost) tubular 866. Equations (10) and (11) may be utilized to determine the azimuthal orientation offsets O_{OL} and O_{OL}.

### Determining Tool Face Offset

Tool face offset is the azimuthal (i.e., angular) orientation relationship between a bent sub or housing of a downhole motor and a directional sensor that may be housed within a downhole sub (e.g., tool), such as a universal bottom hole orienting sub (UBHO) or a drill collar. The drill collar may be that of an MWD mud pulser tool. The tool face offset is measured, for example, between a reference point on the bent housing and on the UBHO or MWD tool, which contains the directional sensor at a known azimuthal orientation with respect to the reference point. The tool face offset may be measured during make-up of a BHA at a wellsite surface, such that the azimuthal orientation of the bent housing of the motor can be determined while downhole when the orientation of the directional sensor is sent to the wellsite surface. The tool face offset can be different for each BHA as the quantity of collar connections, threading tolerance, and torque on each of the connections between the bent housing and the UBHO or MWD tool can be different for each job. Hence, knowing the tool face offset helps to determine the azimuthal orientation of the downhole motor with respect to the high side of a wellbore during directional drilling.

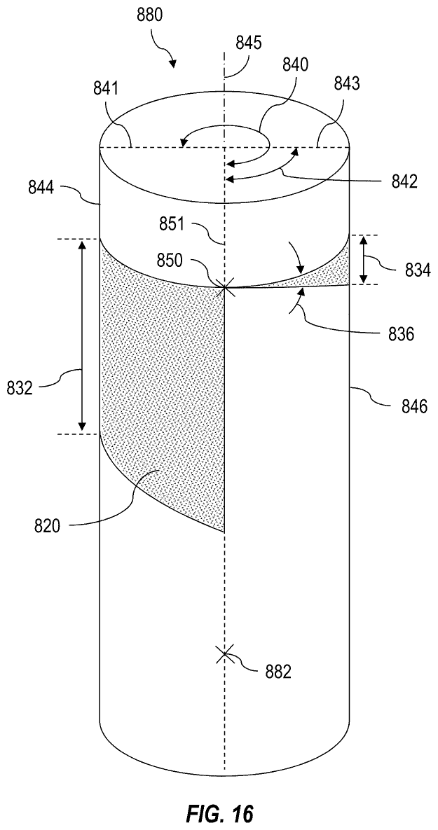

One or more geometric patterns, such as the geometric patterns 820, 822 described above and shown in FIGS. 9-14, may be imparted onto or otherwise utilized in association with each tubular of a BHA to facilitate tracking of the tool face offset while the BHA is assembled at the wellsite surface. FIG. 16 is a perspective view of at least a portion of a downhole tubular 880 of a BHA comprising the geometric pattern 820 described above and shown in FIGS. 9-11 according to one or more aspects of the present disclosure. The geometric pattern 820 may be imparted at the box end of the tubular 880. If the tubular 880 comprises a pin end, a geometric pattern (not shown in FIG. 16), such as the geometric pattern 822, may also be imparted at the pin end of the tubular 880. The tubular 880 may be or comprise, for example, a downhole motor, an MWD tool, and/or a UBHO.

As shown in FIG. 16, the geometric pattern 820 on the tubular 880 may be oriented such that the reference point 850 or line 851 of the geometric pattern 820 coincides with, intercepts, or lies along the same vertical line as a reference point 882 of the tubular 880. However, the reference point 850 or line 851 of the geometric pattern 820 may be azimuthally offset from the reference point 882 of the tubular 880 by a known angle, such that azimuthal orientation of the reference point 850 or line 851 is indicative of the azimuthal orientation of the reference point 882. Such angular relationship can be established with the vision system 800 or the angular relationship may be physically measured and considered in the calculations. If the tubular 880 is or comprises a motor bent sub, the reference point 882 may be or comprise a scribe line indicative of the bent sub tool face. If the tubular 880 is or comprises an MWD tool, the reference point 882 may be or comprise location of a directional sensor of the MWD tool. If the tubular 880 is or comprises a UBHO, the reference point 880 may be or comprise location of a key of the UBHO sleeve.

For a BHA comprising a downhole motor and an MWD tool, the tool face offset (i.e., angular difference) between the reference point 882 of the motor bent sub and the reference point 882 of the MWD tool and/or the UBHO may be determined by utilizing Equations (6) and (7) as described above. For example, Equation (6) may be utilized to determine the azimuthal orientation O₁ 840 of the left edge line 841 with respect to the reference point 850 or line 851 of the geometric pattern 820 and, thus, the reference point 882 (e.g., scribe line), at the box end of the motor. Equation (7) may be utilized to determine the azimuthal orientation O₂ 842 of the right edge line 843 with respect to the reference point 850 or line 851 of the geometric pattern 820 and, thus, the reference point 882, at the box end of the motor. Azimuthal orientation O_{mb} of the box end (motor-box end) of the motor may be or comprise the azimuthal orientation θ₁ 840 or the azimuthal orientation θ₂ 842, as indicated by Equation (12).

O_{mb}=(θ₁;θ₂) (12)

The MDW tool and/or the UBHO may further comprise a geometric pattern, such as the geometric pattern 822, shown in FIGS. 12-14, which may be imparted on the pin end of the MDW tool and/or the UBHO. The geometric pattern 822 may be oriented such that the reference point 850 or line 851 of the geometric pattern 822 coincides with, intercepts, or lies along the same vertical line as a reference point 882 of the MDW tool and/or the UBHO. For example, the reference point 882 may be or comprise location of a directional sensor of the MWD tool. The reference point may also or instead be or comprise location of a key of the UBHO sleeve.

Equations (6) and (7) may also be utilized to determine azimuthal orientations θ₃ 852 and θ₄ 854 of the left and right edge lines 841, 843 with respect to the reference point 850 or line 851 of the geometric pattern 822 and, thus, the reference point 882 (e.g., location of a directional sensor), at the pin end of the MWD (or the UBHO). Azimuthal orientation Oₚₚ of the pin end (MWD-pin end) of the MWD may be or comprise the azimuthal orientation θ₃ 852 and the azimuthal orientation θ₄ 854, as indicated by Equation (13).

Oₘₚ=(θ₃;θ₄) (13)

Azimuthal orientation offset O_{OL} between the reference point 882 (e.g., the scribe line) at the box end of the motor and the reference point 882 (e.g., the location of the directional sensor) at the pin end of the MWD measured with respect to the left edge line 841 motor-MWD connection may be determined by utilizing equation (10). The azimuthal orientation offset O_{OR} between the reference point 882 (e.g., the scribe line) at the box end of the motor and the reference point 882 (e.g., the location of the directional sensor) at the pin end of the MWD measured with respect to the right edge line 843 of the motor-MWD connection may be determined by utilizing equation (11). One or both azimuthal orientation offsets O_{OL} and O_{OR} may be calculated to determine the tool face offset. The tool face offset may be measured in the clockwise direction from the MWD reference point 882 (e.g., the location of the directional sensor) to the motor reference point 882 (e.g., scribe line) while looking downhole.

Equations (6)-(13) may be contained within or captured by program code instructions, which may be executed or otherwise processed by a processing device, such as the processing device 192. During the wellsite operations, Equations (6) and (7) may be utilized to determine the azimuthal orientations θ₁ 840, θ₂ 842, θ₃ 852, θ₄ 854 based on the previously entered equation parameters, such as the angle ∂ 836 of the geometric pattern edge, the diameter D 838 of the downhole motor, the MWD tool, and/or the UBHO, and the measured lengths l₁ 832 and l₂ 834 of the geometric patterns 820, 822. The determined azimuthal orientations θ₁ 840, θ₂ 842, θ₃ 852, θ₄ 854 may be saved onto a memory device (e.g., a memory buffer of the processing device). The determined azimuthal orientations of subsequent tubulars may be tracked and aggregated to determine the orientation of the downhole motor, the MWD tool, and/or the UBHO with respect to the last (i.e., uppermost) tubular. Equations (10) and (11) may then be utilized to determine the azimuthal orientation offsets O_{OL} and O_{OL}.

In the above example, it has been assumed that the MWD tool or the UBHO is directly coupled to the motor bent sub. However, if other tubulars (e.g., collars) are coupled there between, the angular relationship at each intermediate connection will have to be taken into account during the computation of the tool face offset. Moreover, the angular relationship between each connection from the BHA to a tubular at the wellsite surface can be tracked, such as to facilitate control of the orientation of the motor, for example, when a downhole directional sensor is unable to provide measurement in areas of magnetic interference.

If no geometric patterns are imparted on the tubulars 880 of the BHA, the vision system 800 may be configured or otherwise operable to detect the motor reference line and the MWD/UBHO reference points. After the BHA has been made up and the motor reference line has been detected, the BHA would may be lowered into the wellbore while not being rotated. When the MWD/UBHO reference point reaches the same level as that of the motor reference line previously detected, the BHA can be rotated such that the MWD/UBHO reference point coincides with the previous position of the motor reference line. The amount of rotation of the BHA will be indicative of the tool face offset.

### Determining Grading of a Drill Bit

Each time a drill bit is pulled out to the wellsite surface after a run, the drill bit is inspected and graded based on its characteristics. Such grading may be performed pursuant to the International Association of Drilling Contractors (IADC) classification nomenclature and a report indicative of the drill bit grading may be prepared.

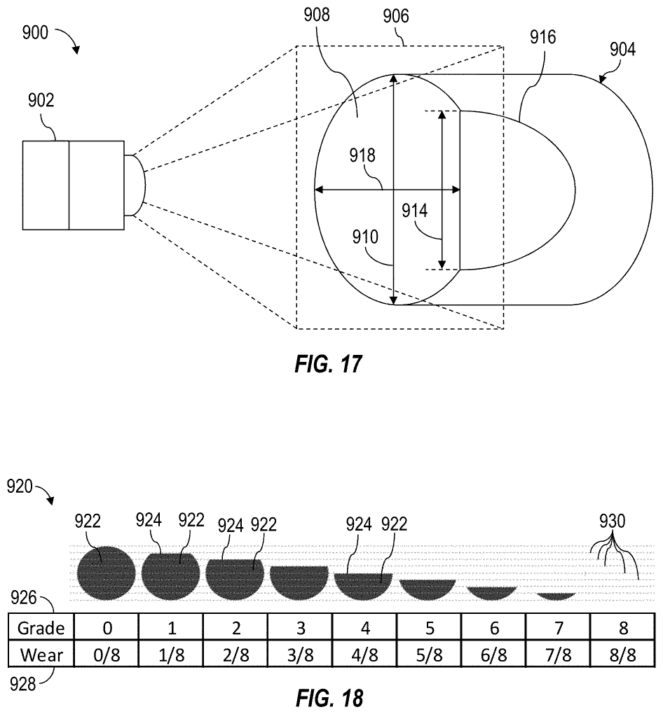

FIG. 17 is a schematic view of at least a portion of example implementations of vision systems 900 operable to determine level of wear of a drill bit according to one or more aspects of the present disclosure. The vision system 900 may be a portion of a well construction system, such as the well construction system 100 shown in FIG. 1, and may be disposed or otherwise utilized in association with other portions of the well construction system 100, including where identified by the same numerals. The vision system 900 may be communicatively connected with a processing device, such as the processing device 192 shown in FIGS. 1 and 2.

The vision system 900 may be operable to identify various characteristics of the drill bit, such as may permit the vision system 900 to automatically generate a drill bit grading report. The vision system 900 or another system communicatively connected with that vision system 900 may compile or otherwise comprise a database of images of different variations of each characteristic of a drill bit. The vision system 900 may utilize machine learning to compare digital images of a drill bit that was pulled to the wellsite surface with the images compiled in the database. In addition, a comparison can be made between the condition of a drill bit before it goes into the hole and the condition after it comes out of the hole, such as to improve grading.

FIG. 18 is a chart 920 comprising a plurality of images of cutter faces 922, each having a different level of wear characterized by the relative location of a wear line 924 along each cutter face 922. The chart 920 further comprises a grade rating 926 and amount of wear 928 associated with a threshold location 930 of the wear line 924 along each cutter face 922. A database of drill bits within the scope of the present disclosure may comprise the chart 920 or other images of cutter faces 922 having different levels of wear and grade ratings associated with each image of cutter face 922. The vision system 900 may, for example, compare digital images (or video frames) of cutters of a drill bit that was pulled to the wellsite surface with the images of the cutter faces 922 in the database.

The vision system 900 may comprise a camera 902 directed toward a drill bit such that one or more drill bit cutters 904 (e.g., polycrystalline diamond compact (PDC) cutters) are within a field of view 906 of the camera 902. The camera 902 may be directed toward the cutters 904 such that corresponding faces 908 of the cutters 904 are within the field of view 906.

Such positioning and direction may permit the camera 902 to capture digital images (or video frames) of one or more cutters 904 encompassed within the field of view 906. The camera 902 may be in signal communication with a processing device. A video signal comprising the captured digital images may be generated by the camera 902 and received by the processing device, which may then process and analyze the digital images. For example, the vision system 900 may be operable to process and analyze the digital images to measure or otherwise determine dimensions of certain features of the cutters 904 and compare such dimensions to those of cutters in images stored in the database. For example, the vision system 900 may determine diameter 910 of the cutter face 908 of the drill bit being graded, length 914 of a wear line 916 along the cutter face 908, and/or location of the wear line 916 along the cutter face 908, such as by measuring distance 918 between the wear line 916 and an opposing edge of the cutter face 908 and/or by determining a proportion or fraction of the distance 918 to the diameter 910 of the cutter face 908.

Such measurements may be performed by tracking the quantity of video pixels spanning such features or measurements of the cutter 904. A correlation factor can be developed between the pixels in the captured digital images to the actual dimensions of the cutter 904 and/or drill bit. Such correlation factor can be utilized to account for attributes, such as height of the camera 902 with respect the cutter 904 and/or drill bit, the angle of the camera 902 with respect to the cutter 904 and/or drill bit, and the distance of the camera 902 from the cutter 904 and/or drill bit. After measuring or determining the pixels in the captured images, the correlation factor may be utilized to convert the determined quantity of pixels spanning across the features of the cutter in the digital images to actual physical dimensions, such as by utilizing one or more of Equations (1) and (5). The vision system 900 may then utilize the actual physical dimensions to determine drill bit characteristics, such as drill bit grade and/or level of wear of the drill bit. The vision system 900 may automatically generate a drill bit grading report based on the determined drill bit characteristics.

### Determining Safety Regulation Compliance

Attention to safety is paramount on drilling rigs. Besides local practices that may be followed by each drilling company, standards and directives are mandated by regulatory authorities, such as OSHA and ANSI. Well construction systems (e.g., drill rigs) often utilize marking and color coding procedures for lifting systems and accessories (e.g., tubular hoisting systems, slings). Lifting accessories and portions of the lifting systems are inspected and if found compliant for purpose, may be painted or otherwise marked with a predetermined color. The color markings may indicate that an inspection was performed, validating use of the lifting systems and accessories for a fixed interval of time (e.g., a month or three months), after which the lifting systems and accessories will again be inspected. Personal protection equipment (PPE) regulations are also enforced at well construction systems. Some PPE regulations vary based on the area of the drill rig a wellsite operator is working. For example, high noise areas, such as the pump room, mandate double ear protection, but the rig floor may not. Furthermore, trainees may be given different colored hats (e.g., green) when working on the drill rig. Oftentimes, trainees have to be accompanied by senior personnel in certain sections of the drill rig.

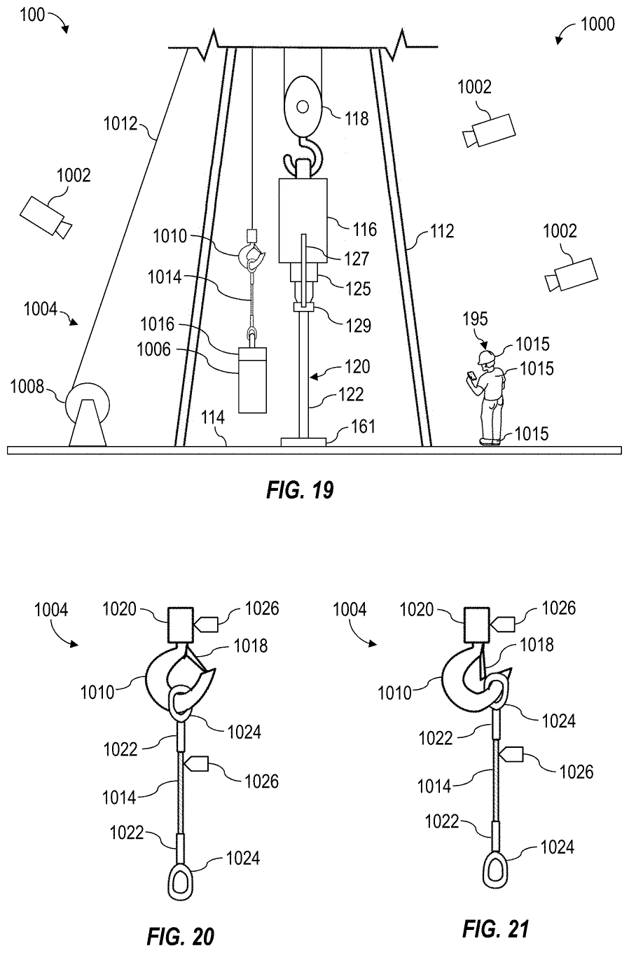

FIG. 19 is a schematic view of at least a portion of example implementations of a vision system 1000 operable to determine compliance with safety regulations, safety standards, and/or top practices according to one or more aspects of the present disclosure. The vision system 1000 may be a portion of a well construction system, such as the well construction system 100 shown in FIG. 1, and may be disposed or otherwise utilized in association with other portions of the well construction system 100, including where identified by the same numerals. The vision system 1000 may be a portion of a control system, such as the control system 200 shown in FIG. 2, and/or a portion of a CCTV system, such as the CCTV system 216 shown in FIGS. 1 and 2. The vision system 1000 may be communicatively connected with a processing device, such as the processing device 192 shown in FIGS. 1 and 2.

The vision system 1000 may comprise a plurality of video cameras 1002 distributed at various locations of the well construction system 100 and directed or aimed toward various lifting equipment of the well construction system 100, such as may permit the cameras 1002 to capture digital images of such equipment to monitor compliance with safety regulations at the well construction system 100. For example, the cameras 1002 may be directed toward selected portions of a winch system 1004 for lifting various tools and equipment 1006 above the rig floor 114. The winch system 1004 may comprise a winch 1008 operatively connected to a hook 1010 via a line 1012. The cameras 1002 may also or instead be directed toward selected lifting accessories, such as lifting slings 1014 utilized to lift the equipment 1006 at the well construction system 100. The equipment 1006 (e.g., downhole tubulars) may be connected directly with the hook 1010 or indirectly via a sling 1014. A lifting cap 1016 or another connector may be utilized to connect some equipment 1006 with the hook 1010 or the sling 1014. The vision system 1000 may also be utilized, for example, to determine if a swivel end of a rotary hose (not shown) is fastened to the swivel with a cable or chain.

Such positioning and direction of the cameras 1002 may permit the cameras 1002 to capture digital images (or video frames) of the winch system 1004 and/or the lifting slings 1014 before and/or during lifting operations. Video signals comprising the digital images generated by the cameras 1002 may be received by the processing device 192, which may then process the digital images to determine mechanical status and/or colors of the winch system 1004 and/or lifting slings 1014 and, thus, determine if the winch system 1004 and lifting slings 1014 are being operated safely and/or if safety regulations are complied with based on the determined colors. Each different color of the hook 1010 and sling 1014 may indicate, for example, validity of a safety inspection for a predetermined period of time. If the processing device 192 determines that the winch system 1004 is operating in an unsafe manner and/or a safety regulation is not complied with, the processing device 192 may automatically initiate an alarm (e.g., a visual and/or audio alarm) indicative of unsafe operation and/or noncompliance with one or more of the safety regulations. Machine learning programs may be implemented to identify unsafe operation and/or safety regulation noncompliance.

The cameras 1002 may also or instead be directed toward the rig floor 114, such as may permit the cameras 1002 to capture digital images of the wellsite operators 195 and the PPE equipment 1015 (e.g., hard hats, ear protections, eye protection, overalls, safety vests, gloves, safety shoes, etc.) worn by the wellsite operators 195, which may indicate compliance with safety regulations by the wellsite operators 195. The PPE equipment 1015 may, thus, also be referred to as “safety regulation compliance indicators 1015.”

Such positioning and direction may permit the cameras 1002 to capture digital images (or video frames) of the PPE equipment 1015 before and/or during drilling and other wellsite operations. Video signals comprising the digital images generated by the cameras 1002 may be received by the processing device 192, which may then process the digital images to determine if the wellsite operators 195 are wearing the mandated PPE equipment 1015. The processing device 192 may also or instead monitor color of selected PPE equipment 1015 (e.g., hard hats), wherein each different color may indicate, for example, if the wellsite operator 195 is working in an assigned or permitted area (e.g., the rig floor 114) of the well construction system 100. If the processing device 192 determines that a wellsite operator 195 is not wearing mandated PPE equipment 1015 or if the wellsite operator 195 is present in an unassigned or forbidden area of the well construction system 100, the processing device 192 may automatically initiate an alarm (e.g., a visual and/or audio alarm). Machine learning programs may be implemented to identify safety regulation noncompliance.

FIGS. 20 and 21 are enlarged views of a portion of the winch system 1004 shown in FIG. 19 according to one or more aspects of the present disclosure. FIG. 20 shows the hook 1010 mechanically coupled with the sling 1014 in a proper (and safe) manner, wherein an eye 1024 (e.g., a loop) of the sling 1014 is fully engaged by the hook 1010 and locked on the hook 1010 by a safety latch 1018 to prevent accidental release of the sling 1014. FIG. 21 shows the hook 1010 mechanically coupled with the sling 1014 in an improper (and unsafe) manner, wherein the eye 1024 of the sling 1014 is not fully engaged by the hook 1010 and not locked on the hook 1010 by the safety latch 1018. The hook 1010 may further comprise a rope socket or another connector 1020 configured to connect the hook 1010 with the line 1012. The sling 1014 may comprise opposing crimped sleeves or other fasteners 1022 configured to form or otherwise facilitate the eyes 1024 of the sling 1014. The connector 1020, the fasteners 1022, and/or safety inspection tags 1026 (or zip ties) connected with the hook 1010 and/or sling 1014 may be painted or otherwise comprise a selected color indicative of compliance with safety regulations associated with such piece of equipment. Each different color may indicate, for example, validity of a safety inspection of the associated piece of equipment for a predetermined period of time. The colored (e.g., painted) connector 1020, fasteners 1022, and/or tags 1026 may, thus, be referred to as “safety regulation compliance indicators 1020, 1022, 1026.”

The cameras 1002 may be directed toward the hook 1010 and the sling 1014, such as may permit the cameras 1002 to capture digital images (or video frames) of the hook 1010 and the sling 1014. Video signals comprising the digital images generated by the cameras 1002 may be received by the processing device 192, which may then process the digital images to determine whether the hook 1010 and the sling 1014 are mechanically coupled in the proper manner, wherein the eye 1024 of the sling 1014 is locked by the safety latch 1018. The processing device 192 may also or instead determine the color of the safety regulation compliance indicators 1020, 1022, 1026 to determine if the safety regulations are complied with. If the processing device 192 determines that the winch system 1004 is operating in an unsafe manner and/or one or more safety regulations are not complied with, the processing device 192 may automatically initiate an alarm (e.g., a visual and/or audio alarm) indicative of unsafe operation and/or noncompliance with the safety regulations. Machine learning programs may be implemented to identify unsafe operation and/or safety regulation noncompliance.

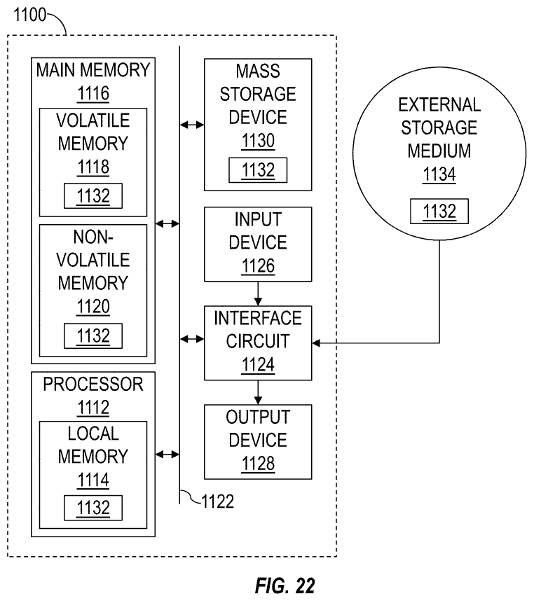

FIG. 22 is a schematic view of at least a portion of an example implementation of a processing system 1100 (or device) according to one or more aspects of the present disclosure. The processing system 1100 may be or form at least a portion of one or more equipment controllers and/or other electronic devices shown in one or more of the FIGS. 1-21. Accordingly, the following description refers to FIGS. 1-22, collectively.

The processing system 1100 may be or comprise, for example, one or more processors, controllers, special-purpose computing devices, PCs (e.g., desktop, laptop, and/or tablet computers), personal digital assistants, smartphones, IPCs, PLCs, servers, internet appliances, and/or other types of computing devices. The processing system 1100 may be or form at least a portion of the processing device 192. The processing system 1100 may be or form at least a portion of the local controllers 221-226. The processing system 1100 may form at least a portion of the cameras 198, 302, 402, 506, 508, 602, 702, 802, 804, 902, 1002. Although it is possible that the entirety of the processing system 1100 is implemented within one device, it is also contemplated that one or more components or functions of the processing system 1100 may be implemented across multiple devices, some or an entirety of which may be at the wellsite and/or remote from the wellsite.

The processing system 1100 may comprise a processor 1112, such as a general-purpose programmable processor. The processor 1112 may comprise a local memory 1114, and may execute machine-readable and executable program code instructions 1132 (i.e., computer program code) present in the local memory 1114 and/or another memory device. The processor 1112 may execute, among other things, the program code instructions 1132 and/or other instructions and/or programs to implement the example methods and/or operations described herein. The program code instructions 1132 stored in the local memory 1114, when executed by the processor 1112 of the processing system 1100, may cause one or more portions or pieces of wellsite equipment of a well construction system to perform the example methods and/or operations described herein. The processor 1112 may be, comprise, or be implemented by one or more processors of various types suitable to the local application environment, and may include one or more of general-purpose computers, special-purpose computers, microprocessors, digital signal processors (DSPs), field-programmable gate arrays (FPGAs), application-specific integrated circuits (ASICs), and processors based on a multi-core processor architecture, as non-limiting examples. Examples of the processor 1112 include one or more INTEL microprocessors, microcontrollers from the ARM and/or PICO families of microcontrollers, embedded soft/hard processors in one or more FPGAs.

The processor 1112 may be in communication with a main memory 1116, such as may include a volatile memory 1118 and a non-volatile memory 1120, perhaps via a bus 1122 and/or other communication means. The volatile memory 1118 may be, comprise, or be implemented by random access memory (RAM), static random access memory (SRAM), synchronous dynamic random access memory (SDRAM), dynamic random access memory (DRAM), RAMBUS dynamic random access memory (RDRAM), and/or other types of random access memory devices. The non-volatile memory 1120 may be, comprise, or be implemented by read-only memory, flash memory, and/or other types of memory devices. One or more memory controllers (not shown) may control access to the volatile memory 1118 and/or non-volatile memory 1120.

The processing system 1100 may also comprise an interface circuit 1124, which is in communication with the processor 1112, such as via the bus 1122. The interface circuit 1124 may be, comprise, or be implemented by various types of standard interfaces, such as an Ethernet interface, a universal serial bus (USB), a third generation input/output (3GIO) interface, a wireless interface, a cellular interface, and/or a satellite interface, among others. The interface circuit 1124 may comprise a graphics driver card. The interface circuit 1124 may comprise a communication device, such as a modem or network interface card to facilitate exchange of data with external computing devices via a network (e.g., Ethernet connection, digital subscriber line (DSL), telephone line, coaxial cable, cellular telephone system, satellite, etc.).

The processing system 1100 may be in communication with various video cameras, sensors, actuators, equipment controllers, and other devices of the well construction system via the interface circuit 1124. The interface circuit 1124 can facilitate communications between the processing system 1100 and one or more devices by utilizing one or more communication protocols, such as an Ethernet-based network protocol (such as ProfiNET, OPC, OPC/UA, Modbus TCP/IP, EtherCAT, UDP multicast, Siemens S7 communication, or the like), a proprietary communication protocol, and/or another communication protocol.

One or more input devices 1126 may also be connected to the interface circuit 1124. The input devices 1126 may permit human wellsite operators 195 to enter the program code instructions 1132, which may be or comprise control commands, operational settings and set-points, processing routines, Equations (1)-(13), and/or various numerical parameters of the Equations (1)-(13), such as the pixel pitch P, the distance D 308 of the visual indicator from the video camera, the height of the image sensor Sₕ of the video camera, the focal length f of the video camera, the image frame height Fₕ, the weight per unit length W_{dp}, the overpull force Fₒ, and the distances lₐ 410, l_{b} 412, l_{c} 414, and T_{b} 418, among other examples. The input devices 1126 may be, comprise, or be implemented by a keyboard, a mouse, a joystick, a touchscreen, a track-pad, a trackball, an isopoint, and/or a voice recognition system, among other examples. One or more output devices 1128 may also be connected to the interface circuit 1124. The output devices 1128 may permit for visualization or other sensory perception of various data, such as sensor data, status data, and/or other example data. The output devices 1128 may be, comprise, or be implemented by video output devices (e.g., an LCD, an LED display, a CRT display, a touchscreen, etc.), printers, and/or speakers, among other examples. The one or more input devices 1126 and the one or more output devices 1128 connected to the interface circuit 1124 may, at least in part, facilitate the HMIs described herein.

The processing system 1100 may comprise a mass storage device 1130 for storing data and program code instructions 1132. The mass storage device 1130 may be connected to the processor 1112, such as via the bus 1122. The mass storage device 1130 may be or comprise a tangible, non-transitory storage medium, such as a floppy disk drive, a hard disk drive, a compact disk (CD) drive, and/or digital versatile disk (DVD) drive, among other examples. The processing system 1100 may be communicatively connected with an external storage medium 1134 via the interface circuit 1124. The external storage medium 1134 may be or comprise a removable storage medium (e.g., a CD or DVD), such as may be operable to store data and program code instructions 1132.

As described above, the program code instructions 1132 may be stored in the mass storage device 1130, the main memory 1116, the local memory 1114, and/or the removable storage medium 1134. Thus, the processing system 1100 may be implemented in accordance with hardware (perhaps implemented in one or more chips including an integrated circuit, such as an ASIC), or may be implemented as software or firmware for execution by the processor 1112. In the case of firmware or software, the implementation may be provided as a computer program product including a non-transitory, computer-readable medium or storage structure embodying computer program code instructions 1132 (i.e., software or firmware) thereon for execution by the processor 1112.

The control system 1100 may be operable to receive the program code instructions 1132. The control system 1100 may be communicatively connected with and operable to receive information (e.g., sensor data, signals, digital images, or other information, etc.) indicative of physical characteristics and/or operational status of various equipment or equipment systems of the well construction system. The control system 1100 may be communicatively connected with a database containing digital images of drill bits having different wear characteristic and the associated wear grading. The control system 1100 may be further operable to process the program code instructions 1132 and the operational status information to generate and output corresponding control commands to one or more pieces of equipment or other controllable devices of the well construction system and, thereby, cause or otherwise implement at least a portion of one or more of the example methods, processes, and/or operations described herein.

In view of the entirety of the present disclosure, including the figures and the claims, a person having ordinary skill in the art will readily recognize that the present disclosure introduces an apparatus comprising a first downhole tubular configured for threadedly coupling with a second downhole tubular and conveyance within a wellbore by an oil and/or gas drilling rig, wherein an outer surface of the first downhole tubular comprises a geometric pattern for determining azimuthal orientation of the first downhole tubular.

The geometric pattern may be or comprise a geometric shape.

The geometric pattern, viewed from a side of the first downhole tubular, may be indicative of the azimuthal orientation of the first downhole tubular.

The geometric pattern may wrap around the outer surface of the first downhole tubular.

A length of the geometric pattern, viewed along an edge of the first downhole tubular, may change with rotation of the first downhole tubular. In such implementations, among others within the scope of the present disclosure, the length of the geometric pattern viewed along the edge of the first downhole tubular may be indicative of the azimuthal orientation of the first downhole tubular.

The geometric pattern may be or comprise a triangle wrapped around the outer surface of the first downhole tubular.

The geometric pattern may be painted, etched, and/or affixed to the outer surface of the first downhole tubular.

The geometric pattern may be a first geometric pattern located closer to a box end of the first downhole tubular, the outer surface of the first downhole tubular may comprise a second geometric pattern located closer to a pin end of the first downhole tubular, and the second geometric pattern may be indicative of the azimuthal orientation of the first downhole tubular.

The apparatus may further comprise: a video camera operable to generate a video signal comprising images of the geometric pattern; and a processing system comprising a processor and a memory storing a computer program code which, when executed, causes the processing system to determine the azimuthal orientation of the first downhole tubular based on the images of the geometric pattern. The processing system may be operable to determine azimuthal orientation of the first downhole tubular based on: a length of the geometric pattern viewed along an edge of the first downhole tubular; and/or an angle of the geometric pattern. The processing system may be operable to determine the azimuthal orientation of the first downhole tubular by determining a length of the geometric pattern viewed along an edge of the first downhole tubular, and the length of the geometric pattern may be indicative of the azimuthal orientation of the first downhole tubular. The processing system may be operable to determine the length of the geometric pattern viewed along the edge of the first downhole tubular by determining a quantity of video pixels spanning the length of the geometric pattern viewed along the edge of the first downhole tubular, and the determined quantity of video pixels may be indicative of the length of the geometric pattern viewed along the edge of the first downhole tubular. The processing system may be operable to convert the determined quantity of video pixels to physical measurements to determine the length of the geometric pattern viewed along the edge of the first downhole tubular utilizing a relationship between: the quantity of video pixels spanning the length of the geometric pattern viewed along the edge of the first downhole tubular; a radial distance of the first downhole tubular from the video camera; a height of an image sensor of the video camera; a focal length of the video camera; heights of the images; and the length of the geometric pattern viewed along the edge of the first downhole tubular.

The geometric pattern may be a first geometric pattern, the azimuthal orientation may be a first azimuthal orientation, an outer surface of the second downhole tubular may comprise a second geometric pattern for determining second azimuthal orientation of the second downhole tubular, and the first and second azimuthal orientations may be collectively indicative of relative azimuthal orientation between the first and second downhole tubulars. In such implementations, among others within the scope of the present disclosure, the apparatus may further comprise: (A) a first video camera operable to generate a first video signal comprising first images of the first geometric pattern on the first downhole tubular while the first tubular extends out of the wellbore; (B) a second video camera operable to generate a second video signal comprising second images of the second geometric pattern on the second downhole tubular while the second tubular is being threadedly coupled with the first tubular; and (C) a processing system comprising a processor and a memory storing a computer program code which, when executed, causes the processing system to determine: (i) the first azimuthal orientation based on the first images of the first geometric pattern after the second downhole tubular is threadedly coupled with the first downhole tubular; (ii) the second azimuthal orientation based on the second images of the second geometric pattern after the second downhole tubular is threadedly coupled with the first downhole tubular; and (iii) the relative azimuthal orientation of the first and second downhole tubulars based on the determined first and second azimuthal orientations. The first downhole tubular may comprise a downhole motor, the first azimuthal orientation may be an azimuthal orientation of a tool face of a bent sub of the downhole motor, the second downhole tubular may comprise an MWD tool, the second azimuthal orientation may be an azimuthal orientation of a directional sensor associated with the MWD tool, and the relative azimuthal orientation may be or comprise a tool face offset between the tool face of the bent sub of the downhole motor and the location of the directional sensor.

The first downhole tubular may be or comprise a drill pipe, a casing joint, a downhole sub, a UBHO sub, an MWD tool, and/or a downhole motor.

The geometric pattern may comprise a reference point azimuthally aligned with or at a known azimuthal offset from a reference point of the first downhole tubular. In such implementations, among others within the scope of the present disclosure, the first downhole tubular may comprise a downhole motor, and the reference point of the first downhole tubular may be or comprise a scribe line indicative of a tool face of a bent sub of the downhole motor. The first downhole tubular may be or comprise an MWD tool, and the reference point of the first downhole tubular may be or comprise a location of a directional sensor of the MWD tool. The first downhole tubular may be or comprise a UBHO sub, and the reference point of the first downhole tubular may be or comprise a location of a key of a UBHO sleeve.

The present disclosure also introduces a method comprising imparting a geometric pattern onto an outer surface of a downhole tubular, wherein the geometric pattern is for determining azimuthal orientation of the downhole tubular while the downhole tubular is threadedly coupled with another downhole tubular for conveyance within a wellbore.

The geometric pattern may be or comprise a geometric shape.

The geometric pattern viewed from a side of the downhole tubular may be indicative of the azimuthal orientation of the downhole tubular.

The geometric pattern may wrap around the downhole tubular.

A length of the geometric pattern viewed along an edge of the downhole tubular may change with rotation of the downhole tubular. In such implementations, among others within the scope of the present disclosure, the length of the geometric pattern viewed along the edge of the downhole tubular may be indicative of the azimuthal orientation of the downhole tubular.

The geometric pattern may be or comprise a triangle wrapped around the outer surface of the first downhole tubular.

Imparting the geometric pattern onto the outer surface of the downhole tubular may comprise painting, etching, and/or affixing the geometric pattern onto the outer surface of the downhole tubular.

The geometric pattern may be a first geometric pattern located closer to a pin end of the downhole tubular, the method may comprise imparting a second geometric pattern onto the outer surface of the downhole tubular at a location closer to a box end of the downhole tubular, and the second geometric pattern may be for determining the azimuthal orientation of the downhole tubular while the downhole tubular is threadedly coupled with another downhole tubular.

The downhole tubular may be or comprise a drill pipe, a casing joint, a downhole sub, a UBHO sub, an MWD tool, and/or a downhole motor.

The geometric pattern may comprise a reference point, and the geometric pattern may be imparted onto the outer surface of the downhole tubular such that the reference point of the geometric pattern is azimuthally aligned with or at a known azimuthal offset from a reference point of the downhole tubular. The downhole tubular may be or comprise a downhole motor, and the reference point of the downhole tubular may be or comprise a scribe line indicative of a tool face of a bent sub of the downhole motor. The downhole tubular may be or comprise an MWD tool, and the reference point of the downhole tubular may be or comprise a location of a directional sensor of the MWD tool. The downhole tubular may be or comprise a UBHO sub, and the reference point of the downhole tubular may be or comprise a location of a key of a UBHO sleeve.

The present disclosure also introduces a method comprising: operating a video camera to generate a signal comprising images of a geometric pattern on an outer surface of a first downhole tubular while the first downhole tubular is being threadedly coupled with a second downhole tubular at an oil and gas wellsite; and operating a processing system to process the signal to determine an azimuthal orientation of the first downhole tubular based on the images of the geometric pattern.

The geometric pattern may be or comprise a geometric shape.

The geometric pattern viewed from a side of the first downhole tubular may be indicative of the azimuthal orientation of the first downhole tubular.

The geometric pattern may wrap around the outer surface of the first downhole tubular.

A length of the geometric pattern viewed along an edge of the first downhole tubular may change with rotation of the first downhole tubular. The length of the geometric pattern viewed along the edge of the first downhole tubular may be indicative of the azimuthal orientation of the first downhole tubular.

The geometric pattern may be or comprise a triangle wrapped around the outer surface of the first downhole tubular.

The geometric pattern may be painted, etched, and/or affixed to the outer surface of the first downhole tubular.

The geometric pattern may be a first geometric pattern located closer to a box end of the first downhole tubular, the outer surface of the first downhole tubular may comprise a second geometric pattern located closer to a pin end of the first downhole tubular, and the second geometric pattern may be indicative of the azimuthal orientation of the first downhole tubular.

Operating the processing system to determine the azimuthal orientation of the first downhole tubular may comprise determining a length of the geometric pattern viewed along an edge of the first downhole tubular, and the length of the geometric pattern may be indicative of the azimuthal orientation of the first downhole tubular.

Determining the length of the geometric pattern viewed along the edge of the first downhole tubular may comprise determining a quantity of video pixels spanning the length of the geometric pattern viewed along the edge of the first downhole tubular, and the determined quantity of video pixels may be indicative of the length of the geometric pattern viewed along the edge of the first downhole tubular. Determining the length of the geometric pattern viewed along the edge of the first downhole tubular may comprise converting the determined quantity of video pixels to physical measurements based on a relationship between: the quantity of video pixels spanning the length of the geometric pattern viewed along the edge of the first downhole tubular; a radial distance of the first downhole tubular from the video camera; a height of an image sensor of the video camera; a focal length of the video camera; heights of the images; and the length of the geometric pattern viewed along the edge of the first downhole tubular.

The method may further comprise: (A) for each subsequent downhole tubular threadedly coupled above the first downhole tubular, generating a signal comprising images of a geometric pattern on an outer surface of each subsequent downhole tubular; and (B) operating the processing system to: (i) process each signal to determine an azimuthal orientation of each subsequent downhole tubular; and (ii) determine a current azimuthal orientation of the first downhole tubular based on the first azimuthal orientation and the azimuthal orientation of each subsequent downhole tubular.

The signal may be a first signal, the geometric pattern may be a first geometric pattern, the azimuthal orientation may be a first azimuthal orientation, and the method may further comprise: (A) operating the video camera to generate a second signal comprising images of a second geometric pattern on an outer surface of the second downhole tubular; and (B) operating the processing system to: (i) process the second signal to determine a second azimuthal orientation of the second downhole tubular; and (ii) determine a current azimuthal orientation of the first downhole tubular based on the first and second azimuthal orientations.

The geometric pattern may be a first geometric pattern, the azimuthal orientation may be a first azimuthal orientation, an outer surface of the second downhole tubular may comprise a second geometric pattern for determining second azimuthal orientation of the second downhole tubular, and the first and second azimuthal orientations may be collectively indicative of relative azimuthal orientation between the first and second downhole tubulars. The video camera may be a first video camera, the signal may be a first signal, the images may be first images, operating the first video camera may be performed while the first tubular extends out of the wellbore, and the method may further comprise: (A) operating a second video camera to generate a second signal comprising second images of the second geometric pattern on the second downhole tubular while the second tubular is being threadedly coupled with the first tubular; and (B) operating the processing system to determine: (i) the first azimuthal orientation based on the first images of the first geometric pattern after the second downhole tubular is threadedly coupled with the first downhole tubular; (ii) the second azimuthal orientation based on the second images of the second geometric pattern after the second downhole tubular is threadedly coupled with the first downhole tubular; and (iii) the relative azimuthal orientation of the first and second downhole tubulars based on the determined first and second azimuthal orientations. The first downhole tubular may comprise a downhole motor, the first azimuthal orientation may be an azimuthal orientation of a tool face of a bent sub of the downhole motor, the second downhole tubular may comprise an MWD tool, the second azimuthal orientation may be an azimuthal orientation of a directional sensor associated with the MWD tool, and the relative azimuthal orientation may be or comprise a tool face offset between the tool face of the bent sub of the downhole motor and the location of the directional sensor.

The first downhole tubular may be or comprise a drill pipe, a casing joint, a downhole sub, a UBHO sub, an MWD tool, and/or a downhole motor.

The geometric pattern may comprise a reference point azimuthally aligned with or at a known azimuthal offset from a reference point of the first downhole tubular. The first downhole tubular may comprise a downhole motor, and the reference point of the first downhole tubular may be or comprise a scribe line indicative of a tool face of a bent sub of the downhole motor. The first downhole tubular may be or comprise an MWD tool, and the reference point of the first downhole tubular may be or comprise a location of a directional sensor of the MWD tool. The first downhole tubular may be or comprise a UBHO sub, and the reference point of the first downhole tubular may be or comprise a location of a key of a UBHO sleeve.

The present disclosure also introduces a method comprising: operating a video camera to generate a video signal comprising images encompassing a top of a tubular extending above an elevator of a drill rig at an oil and gas wellsite while the tubular is retained by the elevator; and operating a processing system to process the video signal to determine a height of the top of the tubular relative to the rig floor of the drill rig, wherein the processing system comprises a processor and a memory storing a computer program code.

The tubular may be a section of drill pipe and/or casing.

Operating the processing system may comprise determining a distance between the top of the tubular and the top of the elevator by determining a quantity of video pixels spanning between the top of the tubular box end and the top of the elevator, and the determined quantity of video pixels may be indicative of the distance between the top of the tubular and the top of the elevator. Determining the distance between the top of the tubular and the top of the elevator may comprise converting the determined quantity of video pixels to physical measurements. Converting the determined quantity of video pixels to physical measurements may be based on a radial distance of the drill pipe from the video camera, a height of an image sensor of the video camera, a focal length of the video camera, and height of the images.

Determining the height of the top of the tubular from the rig floor may be based on: a block position having a known distance between a predetermined reference point of a traveling block or top drive of the drill rig and the rig floor; a distance between upper eyes of tubular handling assembly links of the top drive; a distance between lower eyes of the tubular handling assembly links and the top of the elevator; and a distance between the upper eyes and the lower eyes.

The tubular may be an upper tubular threadedly coupled with a lower tubular extending from a wellbore to a stick up height, and the method may further comprise determining length of the upper tubular based on the stick up height and the determined height of the top of the upper tubular from the rig floor.

The video camera may be a first video camera, the video signal may be a first video signal, and the method may further comprise: (A) tripping the tubular within a wellbore; (B) operating a second video camera to generate a second video signal comprising images encompassing the top of the tubular extending above the elevator while the tubular is retained by the elevator; and (C) operating a processing system to: (i) process the second video signal to determine the height of the top of the tubular relative to the rig floor of the drill rig; and (ii) cause the tripping of the tubular within the wellbore to stop when the determined height of the top of the tubular reaches a predetermined stick up height.

The present disclosure also introduces a method comprising: operating a video camera to generate a video signal comprising images encompassing at least a portion of a crown block of a hoisting system of an oil and gas drill rig; and operating a processing system to process the video signal to determine when a traveling block or elevator of the hoisting system is within a threshold distance from the crown block, wherein the processing system comprises a processor and a memory storing a computer program code.

Operating the processing system may comprise determining a distance between the crown block and the traveling block or elevator by determining a quantity of video pixels spanning between the crown block and the traveling block or elevator, and the determined quantity of video pixels may be indicative of the distance between the crown block and the traveling block or elevator. The method may further comprise converting the determined quantity of video pixels to physical measurements to determine the distance between the crown block and the traveling block or elevator by utilizing a relationship between: the quantity of video pixels spanning between the crown block and the traveling block or elevator; a radial distance of the crown block from the video camera; a height of an image sensor of the video camera; a focal length of the video camera; heights of the images; and the distance between the crown block and the traveling block or elevator.

Operating the processing system may comprise automatically causing the traveling block to stop or reduce speed of upward movement when the traveling block or elevator is within the threshold distance from the crown block.

Operating the processing system may comprise automatically initiating a visual and/or audio alarm when the traveling block or elevator is within the threshold distance from the crown block.

The present disclosure also introduces a method comprising: operating a video camera to generate a video signal comprising images encompassing at least a portion of a drawworks of a hoisting system of an oil and gas drill rig; and operating a processing system to process the video signal to determine when a traveling block or elevator of the hoisting system is within a threshold distance from the crown block, wherein the processing system comprises a processor and a memory storing a computer program code.

Operating the processing system may comprise determining a length of cable wrapped around a drum of the drawworks, and the determined length of the cable may be indicative of distance between the crown block and the traveling block or elevator. Determining the length of cable wrapped around the drum may comprise determining a quantity of layers and/or wraps of the cable around the drum. Determining the quantity of layers and/or wraps of the cable wrapped around the drum may comprise determining height and/or width of the cable wrapped around the drum.

Operating the processing system may comprise automatically causing the traveling block to stop or reduce speed of upward movement when the traveling block or elevator is within the threshold distance from the crown block.

The present disclosure also introduces a method comprising monitoring alignment between a pin end of an upper tubular and a box end of a lower tubular during tubular make up operations at an oil and gas wellsite by: operating a first video camera to generate a first video signal comprising first images encompassing the pin end of the upper tubular and the box end of the lower tubular; operating a second video camera to generate a second video signal comprising second images encompassing the pin end of the upper tubular and the box end of the lower tubular, wherein the first and second video cameras are directed at the pin end of the upper tubular and the box end of the lower tubular from different angles; and operating a processing system to process the first and second video signals to determine an amount of misalignment between the pin end of the upper tubular and the box end of the lower tubular captured in the first and second images, wherein the processing system comprises a processor and a memory storing a computer program code.

Operating the processing system to process the first and second video signals may comprise determining relative positions of edges of the pin end of the upper tubular and edges of the box end of the lower tubular captured in the first and second images.

Operating the processing system to process the first and second video signals to determine the amount of misalignment between the pin end of the upper tubular and the box end of the lower tubular may comprise determining horizontal distances between edges of the pin end of the upper tubular and edges of the box end of the lower tubular captured in the first and second images. Determining horizontal distances between the edges of the pin end of the upper tubular and the edges of the box end of the lower tubular captured in the first and second images may comprise: determining a first quantity of video pixels spanning horizontally between a first of the edges of the pin end of the upper tubular and a first of the edges of the box end of the lower tubular captured in the first images, wherein the determined first quantity of video pixels may be indicative of a first of the horizontal distances between the first edge of the pin end of the upper tubular and the first edge of the box end of the lower tubular; and determining a second quantity of video pixels spanning horizontally between a second of the edges of the pin end of the upper tubular and a second of the edges of the box end of the lower tubular captured in the second images, wherein the determined second quantity of video pixels may be indicative of a second of the horizontal distances between the second edge of the pin end of the upper tubular and the second edge of the box end of the lower tubular. The method may further comprise converting the determined first and second quantities of video pixels to physical measurements to determine the first and second horizontal distances, for each one of the first and second cameras, based on a relationship between: the determined quantity of video pixels; a radial distance of the lower tubular from that camera; a height of the image sensor of that camera; a focal length of that camera; a height of the images; and the corresponding first or second horizontal distance.

Operating the processing system may comprise automatically initiating a visual and/or audio alarm when the determined amount of misalignment between the pin end of the upper tubular and the box end of the lower tubular exceeds a predetermined threshold.

The first and second tubulars may be drill pipes, drill collars, or casing joints.

The present disclosure also introduces a method comprising: operating a video camera to generate a signal comprising an image of at least a portion of a drill bit for drilling a wellbore; and operating a processing system to process the signal to determine an amount of wear experienced by the drill bit, wherein the processing system comprises a processor and a memory storing a computer program code.

Operating the processing system may comprise: comparing the image with those in a database of images of other drill bits each associated with a known amount of wear; and determining the amount of wear experienced by the drill bit by assigning to the drill bit the known amount of wear associated with one of the other drill bits from the images in the database that most closely resembles the drill bit.

Operating the processing system may comprise: measuring a dimension of a feature of a cutter of the drill bit; and determining the amount of wear experienced by the drill bit based on the measured dimension of the feature of the cutter. The feature may be or comprise a wear line along a face of the cutter, and the dimension may comprise a length of the wear line. The feature may be or comprise a wear line along a face of the cutter, and the dimension may comprise a distance between the wear line and an edge of the face of the cutter. The feature may be or comprise a face of the cutter, and the dimension may comprise diameter of the face of the cutter. Measuring the feature of the cutter may comprise determining quantity of video pixels spanning the dimension of the feature of the cutter. The method may further comprise converting the determined quantity of video pixels to physical measurements based on a relationship between: the quantity of video pixels spanning the dimension of the feature of the cutter; a distance of the drill bit from the video camera; a height of an image sensor of the video camera; a focal length of the video camera; a height of the image; and the length of the dimension of the feature of the cutter.

The method may comprise automatically generating a report comprising grading of the drill bit based on the determined amount of wear experienced by the drill bit.

The present disclosure also introduces a method comprising: (A) operating a video camera at an oil and gas wellsite to generate a signal comprising images encompassing safety regulation compliance indicators; and (B) operating a processing system to: (i) process the signal to determine compliance with the safety regulations at the oil and gas wellsite; and (ii) initiate an alarm when the processed signal is indicative of noncompliance with one or more of the safety regulations.

Operating the processing system to process the signal to determine compliance with the safety regulations may comprise determining presence and/or color of the safety regulation compliance indicators.

The safety regulation compliance indicators may comprise PPE. The PPE may comprise at least one of overalls, safety shoes, gloves, ear protection, eye protection, and hard hats.

The safety regulation compliance indicators may comprise color of a portion of a lifting system, color of a portion of a lifting sling, and/or color of a safety inspection tag. Each different color of the safety regulation compliance indicators may indicate validity of a safety inspection for a predetermined period of time, and the alarm may be initiated when the determined color of one or more of the safety regulation compliance indicators indicate that a safety inspection for a current period of time was not performed.

The present disclosure also introduces a method comprising: (A) operating a video camera to capture: (i) a first image of a mark located on a first tubular while the first tubular is engaged by a top drive and a second tubular coupled with the first tubular is engaged by slips of a drilling rig comprising the top drive; and (ii) a second image of the mark while the first tubular remains engaged by the top drive and the second tubular is not engaged by the slips; and (B) determining an amount of stretch of the first tubular by determining a change in position of the mark among the first and second images, wherein determining the mark position change among the first and second images comprises operating a processing system comprising a processor and a memory storing computer program code.

Determining the mark position change among the first and second images may comprise determining a quantity of video pixels interposing respective first and second positions of the mark in the first and second images. Determining the stretch amount may be based on the determined quantity of video pixels and a predetermined relationship. The method may further comprise converting the determined quantity of video pixels to a physical measurement to determine the stretch amount based on a relationship between: the determined quantity of video pixels; a radial distance of the first tubular from the video camera; and a focal length of the video camera.

The method may further comprise: operating the video camera to capture additional images of additional marks on additional tubulars as each additional tubular is added to a string of tubulars comprising the first and second tubulars; determining an amount of stretch of each additional tubular by determining a change in position of the additional mark among the first and second images of that additional tubular; and determining an amount of stretch of the string of tubulars based on the determined amount of stretch of each individual tubular.

The mark may be or comprise a physical feature of the first tubular.

The mark may be or comprise a visual feature that is painted on an outer surface of the first tubular.

The mark may be or comprise a visual feature that is etched on an outer surface of the first tubular.

The mark may be or comprise a visual feature that is affixed to an outer surface of the first tubular.

The present disclosure also introduces a method comprising: (A) operating a video camera to generate a video signal comprising images encompassing a mark located on an uppermost tubular of a tubular string comprising a plurality of tubulars extending within a wellbore at an oil and gas wellsite; and (B) determining a depth (D) at which the tubular string is stuck within the wellbore by: (i) pulling the tubular string while determining a resulting amount of stretch (5) of the uppermost tubular; and (ii) determining D based at least partially on the determined S.

Determining D at which the tubular string is stuck within the wellbore may further comprise, before pulling the tubular string while determining the resulting amount of S of the uppermost tubular: (i) pulling the tubular string to its neutral weight; and (ii) determining an overpull force (F) based on a weight per unit length (W) of each tubular of the tubular string. Pulling the tubular string while determining the resulting amount of S of the uppermost tubular may comprise pulling the tubular string with the determined F while determining the resulting amount of S of the uppermost tubular, and determining D based at least partially on the determined S may comprise determining D based on a predetermined relationship between D, F, W, and S. The predetermined relationship may be D=(S×W)/F.

Determining the resulting amount of S may comprise determining a change in position of the mark within the images. Determining the change in position of the mark within the images comprises operating a processing system comprising a processor and a memory storing computer program code. Determining the change in position of the mark within the images may comprise determining a quantity of video pixels interposing respective first and second positions of the mark within corresponding first and second images. The method may further comprise converting the determined quantity of video pixels to a physical measurement to determine the resulting amount of S based on a relationship between: the determined quantity of video pixels; a radial distance of the uppermost tubular from the video camera; and a focal length of the video camera.

The mark may be or comprise a physical feature of the uppermost tubular.

The mark may be or comprise a visual feature that is painted on an outer surface of the uppermost tubular.

The mark may be or comprise a visual feature that is etched on an outer surface of the uppermost tubular.

The mark may be or comprise a visual feature that is affixed to an outer surface of the uppermost tubular.

The foregoing outlines features of several embodiments so that a person having ordinary skill in the art may better understand the aspects of the present disclosure. A person having ordinary skill in the art should appreciate that they may readily use the present disclosure as a basis for designing or modifying other processes and structures for carrying out the same functions and/or achieving the same benefits of the embodiments introduced herein. A person having ordinary skill in the art should also realize that such equivalent constructions do not depart from the spirit and scope of the present disclosure, and that they may make various changes, substitutions and alterations herein without departing from the spirit and scope of the present disclosure.

The Abstract at the end of this disclosure is provided to comply with 37 C.F.R. § 1.72(b) to permit the reader to quickly ascertain the nature of the technical disclosure. It is submitted with the understanding that it will not be used to interpret or limit the scope or meaning of the claims.

What is claimed is:

1. A method comprising:
monitoring alignment between a pin end of an upper tubular and a box end of a lower tubular during tubular make up operations at an oil and gas wellsite by:
operating a first video camera to generate a first video signal comprising first images encompassing the pin end of the upper tubular and the box end of the lower tubular;
operating a second video camera to generate a second video signal comprising second images encompassing the pin end of the upper tubular and the box end of the lower tubular, wherein the first and second video cameras are directed at the pin end of the upper tubular and the box end of the lower tubular from different angles; and
operating a processing system to process the first and second video signals to determine an amount of misalignment between the pin end of the upper tubular and the box end of the lower tubular captured in the first and second images, wherein the processing system comprises a processor and a memory storing a computer program code.

2. The method of claim 1 wherein operating the processing system to process the first and second video signals comprises determining relative positions of edges of the pin end of the upper tubular and edges of the box end of the lower tubular captured in the first and second images.

3. The method of claim 1 wherein operating the processing system to process the first and second video signals to determine the amount of misalignment between the pin end of the upper tubular and the box end of the lower tubular comprises determining horizontal distances between edges of the pin end of the upper tubular and edges of the box end of the lower tubular captured in the first and second images.

4. The method of claim 3 wherein determining horizontal distances between the edges of the pin end of the upper tubular and the edges of the box end of the lower tubular captured in the first and second images comprises:
determining a first quantity of video pixels spanning horizontally between a first of the edges of the pin end of the upper tubular and a first of the edges of the box end of the lower tubular captured in the first images, wherein the determined first quantity of video pixels is indicative of a first of the horizontal distances between the first edge of the pin end of the upper tubular and the first edge of the box end of the lower tubular; and
determining a second quantity of video pixels spanning horizontally between a second of the edges of the pin end of the upper tubular and a second of the edges of the box end of the lower tubular captured in the second images, wherein the determined second quantity of video pixels is indicative of a second of the horizontal distances between the second edge of the pin end of the upper tubular and the second edge of the box end of the lower tubular.

5. The method of claim 1 wherein operating the processing system further comprises automatically initiating a visual and/or audio alarm when the determined amount of misalignment between the pin end of the upper tubular and the box end of the lower tubular exceeds a predetermined threshold.

6. The method of claim 1 wherein the first and second tubulars are drill pipes, drill collars, or casing joints.

7. A method comprising:
operating a video camera to generate a signal comprising an image of at least a portion of a drill bit for drilling a wellbore; and
operating a processing system to process the signal to determine an amount of wear experienced by the drill bit, wherein the processing system comprises a processor and a memory storing a computer program code.

8. The method of claim 7 wherein operating the processing system comprises:
comparing the image with those in a database of images of other drill bits each associated with a known amount of wear; and
determining the amount of wear experienced by the drill bit by assigning to the drill bit the known amount of wear associated with one of the other drill bits from the images in the database that most closely resembles the drill bit.

9. The method of claim 7 wherein operating the processing system comprises:
measuring a dimension of a feature of a cutter of the drill bit; and
determining the amount of wear experienced by the drill bit based on the measured dimension of the feature of the cutter.

10. The method of claim 9 wherein the feature is or comprises a wear line along a face of the cutter, and wherein the dimension comprises a length of the wear line.

11. The method of claim 9 wherein the feature is or comprises a wear line along a face of the cutter, and wherein the dimension comprises a distance between the wear line and an edge of the face of the cutter.

12. The method of claim 9 wherein measuring the feature of the cutter comprises determining quantity of video pixels spanning the dimension of the feature of the cutter.

13. The method of claim 12 further comprising converting the determined quantity of video pixels to physical measurements based on a relationship between:
the quantity of video pixels spanning the dimension of the feature of the cutter;
a distance of the drill bit from the video camera;
a height of an image sensor of the video camera;
a focal length of the video camera;
a height of the image; and
the length of the dimension of the feature of the cutter.

14. The method of claim 7 further comprising automatically generating a report comprising grading of the drill bit based on the determined amount of wear experienced by the drill bit.

15. A method comprising:
operating a video camera at an oil and gas wellsite to generate a signal comprising images encompassing safety regulation compliance indicators;
operating a processing system to:
process the signal to determine compliance with the safety regulations at the oil and gas wellsite; and
initiate an alarm when the processed signal is indicative of noncompliance with one or more of the safety regulations.

16. The method of claim 15 wherein operating the processing system to process the signal to determine compliance with the safety regulations comprises determining presence and/or color of the safety regulation compliance indicators.

17. The method of claim 15 wherein the safety regulation compliance indicators comprise personal protection equipment (PPE).

18. The method of claim 17 wherein the PPE comprises at least one of overalls, safety shoes, gloves, ear protection, eye protection, and hard hats.

19. The method of claim 15 wherein the safety regulation compliance indicators comprise color of a portion of a lifting system, color of a portion of a lifting sling, and/or color of a safety inspection tag.

20. The method of claim 19 wherein:
each different color of the safety regulation compliance indicators indicates validity of a safety inspection for a predetermined period of time; and
the alarm is initiated when the determined color of one or more of the safety regulation compliance indicators indicate that a safety inspection for a current period of time was not performed.
